(19) United States
(12) Patent Application Publication
(10) Pub. No.: US 2026/0367280 A1
(43) Pub. Date: Nov. 19, 2026

(54) GEOSTATISTICAL METHODS FOR DEVELOPING SITE PLANS

(71) Applicant: UNIVERSITY OF WYOMING, Laramie, WY (US)

(72) Inventors: Kam Weng NG, Laramie, WY (US); Opeyemi Emmanuel OLUWATUYI, Laramie, WY (US); Shaun S. WULFF, Laramie, WY (US)

(21) Appl. No.: 19/135,605

(22) PCT Filed: Dec. 7, 2023
(86) PCT No.: PCT/US2023/082849

§ 371 Date: Jun. 4, 2025

Related U.S. Application Data
(60) Provisional application No. 63/430,771, filed on Dec. 7, 2022.

(51) Int. Cl. G01V 20/00; E02D 1/02

(52) U.S. Cl. CPC G01V 20/00; E02D 1/025; G01V 2210/665

(57) ABSTRACT

Embodiments of the present disclosure generally relate to methods of developing site plans, and more specifically to geostatistical methods for developing a site plan. Unlike conventional methods, embodiments described herein can be efficient, cost-effective, and reliable. Embodiments described herein produce site plans with a high degree of confidence in, for example, soil selection. Methods of drilling one or more boreholes based on a site investigation plan are also described. Systems for drilling a borehole are also described.

### FIELD

Embodiments of the present disclosure generally relate to methods for developing a site plan.

### BACKGROUND

Geological, ground, and geotechnical predictions are generally involved in foundation designs among other geotechnical-structural analyses. These predictions are performed due to the limited number of boreholes that can be drilled on sites. Geological predicted surfaces include geomaterial types and their boundaries as sampled from a site investigation, such as drilled boreholes. Ground predicted surfaces include quantitative geomaterial properties as measured in the laboratory or in situ. Geotechnical predictions include a transformation equation or static analysis method where a geomaterial property is utilized in predicting geotechnical-structural capacity. Each of these predictions has an associated degree of uncertainty due to the limited site investigation which can affect foundation design and construction. Some estimates indicate that geological property and ground property uncertainties contribute 20% or more to geotechnical challenges such as ground instability. Geological uncertainty can be more than that of ground uncertainty because the variation in the geomaterial property of different geomaterial types may exceed the variation of geomaterial property within the same geomaterial type. Hence, the behavior of a structure may be more affected by the geomaterial type configuration, layer boundaries, and the geological uncertainties of the site.

The impact of uncertainty characterization and its quantification has been studied on the reliability-based design of driven piles. However, these studies focus on the uncertainties connected to the ground and/or the geotechnical predictions while uncertainty related to the geological prediction is a missing element during pile design. Even in those studies that include geological uncertainty, conventional methods for predicting such uncertainties are deficient. Because of these uncertainties in the design and the impossibility of having boreholes drilled in all locations on a site, the state of the art-current site investigation plan (CSIP)—is flawed. Such flaws lead to challenges in selecting the corresponding number and location of boreholes in a multiphase site investigation plan.

There is a need for new and improved methods for developing a site plan. There is also a need for methods to obtain quality information for sustainable deep foundation design.

### SUMMARY

Embodiments of the present disclosure generally relate to methods of developing site plans, and more specifically to geostatistical methods for developing a site plan. Embodiments of the present disclosure are also related to improving the design and construction of pile foundation systems for various applications, such as highway bridges, buildings, and civil infrastructures. Unlike conventional methods, embodiments described herein take into account geological uncertainty and ground uncertainty. Embodiments of the present disclosure are efficient, cost-effective, and reliable. Embodiments described herein produce site plans with a high degree of confidence in, for example, soil selection.

In an embodiment, a method of determining borehole selection in a geomaterial is provided. The method includes receiving input data from a site, the input data comprising a known geological property, a known ground property, or combinations thereof. The method further includes generating a geostatistical prediction and simulation on a random field based on the input data, the generating the geostatistical prediction and simulation on the random field based on the input data comprising: determining a geological uncertainty of an unknown geological property at an unsampled spatial location of the random field; and determining a ground uncertainty of an unknown ground property at the unsampled spatial location (s₀) of the random field. The method further includes determining an estimated number of one or more boreholes, an estimated location of one or more boreholes, or combinations thereof, based on the geological uncertainty and the ground uncertainty.

In another embodiment, a method of drilling one or more boreholes at a site is provided. The method includes producing a site investigation plan, comprising: (a) discretizing a random field into several three-dimensional grids; (b) assigning a known geological property to a grid location of the three-dimensional grids, the known geological property based on actual borehole data of actual boreholes; (c) estimating a three-dimensional transition rate of the known geological property using a spatial Markov chain; (d) predicting an unknown geological property at an unsampled location of the discretized random field by performing a multinomial categorical prediction; (e) performing Monte Carlo simulations on the unknown geological property to generate a plurality of realizations; (f) characterizing stratigraphic boundaries of each realization of the plurality of realizations to produce stratified realizations; (g) assigning a log-transformed known ground property to the stratigraphic boundaries to form a spatial model, the known ground property based on actual borehole data; (h) fitting the spatial model with a spatial correlation structure of the log-transformed known ground property; (i) predicting an unknown ground property containing the unknown geological property at unsampled locations of the stratified realizations based on the spatial model fit in (h); (j) performing conditional simulations on the unknown ground property containing the unknown geological property in the random field to determine ground uncertainty and geological uncertainty resulting from the unknown ground property and unknown geological property, respectively; (k) applying the actual boreholes to the conditional simulations of (j); (l) adding a plurality of virtual boreholes to locations in the conditional simulations of (j) to provide a plurality of standard deviation values associated with each virtual borehole of the plurality of virtual boreholes; (m) selecting a recommended borehole location based on the virtual borehole having the lowest standard deviation value determined in (l); and (n) determining an estimated number of boreholes as a number where an additional virtual borehole has a minimal effect on the standard deviation value determined in (m). The method further includes drilling one or more boreholes in accordance with the site investigation plan.

In another embodiment, a method for generating a site investigation plan for a pile design is provided. The method includes receiving input data, the input data comprising a known geological property, a known ground property, or combinations thereof. The method further includes performing a geostatistical prediction simulation on a random field to predict an unknown ground property at an unsampled pile location based on the input data, the unsampled pile location having a known pile location, an unknown geological property, and the unknown ground property. The method further includes using the predicted unknown ground property at the unsampled location that is simulated on the random field at the known pile location to determine whether the known pile location has a sufficient end-bearing resistance.

In another embodiment, a method of determining borehole selection is provided. The method includes receiving input data from a site or a random field, the input data comprising a geological property, a ground property, or combinations thereof. The method further includes generating a geostatistical prediction and simulation on the site or random field. The method further includes determining an estimated number of one or more boreholes, an estimated location of one or more boreholes, or combinations thereof, based on the prediction and simulation.

In another embodiment, a method of drilling one or more boreholes is provided. The method includes determining a site investigation plan according to a method described herein, and drilling one or more boreholes in accordance with the site investigation plan.

In another embodiment, a system of drilling a borehole is provided. The system includes a processor, a memory coupled to the processor, and computer software instructions stored in the memory and executable by the processor. The computer software instructions include instructions for: receiving information regarding a geological property, a ground property, or combinations thereof of a site or random field; generating a geostatistical prediction and simulation on the site or random field; and determining an estimated number of one or more boreholes, an estimated location of one or more borehole, or combinations thereof, based on the prediction and simulation.

In another embodiment is provided a method for improving borehole selection in a site investigation plan and reducing the geomaterial uncertainty at a site. The method can utilize an initial site investigation plan as the input data. The method can include generating geostatistical prediction and simulations on the site or random field and obtaining an estimated number and locations of boreholes for the site investigation plan. In some examples, a method for incorporating an ESIP into pile design includes using a site investigation plan as input data, generating geostatistical prediction simulations on the random field and using the geomaterial property simulated on the random field at the pile location. The pile can be designed using an equation specific to the geomaterial and pile type.

In another embodiment, a method of generating an ESIP can include input data from CSIP boreholes in proximity of a pile foundation. Geological and ground characterization of the site can be performed by predicting the geomaterial types and geomaterial properties at the unsampled locations of the random field. Multiple simulations can be performed on the random field to propagate its uncertainties. Boreholes can be placed at strategic locations on the random field to minimize uncertainties.

In another embodiment, a method for incorporating an ESIP into pile design is provided. The method includes input data from the ESIP boreholes re-simulated to characterize geology and ground properties at unsampled locations of the random field. The pile is designed based on the geomaterial property simulated on the random field at the exact pile location and is inputted into an equation specific to the geomaterial type and pile type.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1 is a flowchart of an example site investigation plan (ESIP) algorithm for pile design considering both geological and ground uncertainties according to at least one embodiment of the present disclosure.

FIG. 2 shows a bridge project site plan according to at least one embodiment of the present disclosure.

FIGS. 3A and 3B are three-dimensional (3D) plots of a borehole layout showing geological and ground properties of the bridge project site plan before (FIG. 3A) and after (FIG. 3B) removing boreholes according to at least one embodiment of the present disclosure.

FIG. 4 is a 3D simulated subsurface plot for a study site according to at least one embodiment of the present disclosure.

FIGS. 5A and 5B show a pictorial explanation of recommended borehole selection for ESIP according to at least one embodiment of the present disclosure.

FIG. 6 is a scree plot of actual and recommended boreholes utilized to select an estimated number of boreholes according to at least one embodiment of the present disclosure.

FIG. 7 is a 3D plot of ESIP boreholes according to at least one embodiment of the present disclosure.

FIG. 8 shows validation data for ESIP compared to actual borehole data according to at least one embodiment of the present disclosure.

FIG. 9 is a 3D plot of a site showing pile design using CSIP according to at least one embodiment of the present disclosure.

FIG. 10A is a 3D plot of a site showing simulated ground properties according to at least one embodiment of the present disclosure.

FIG. 10B is a 3D plot of a site showing pile design using ESIP and geostatistical simulation according to at least one embodiment of the present disclosure.

FIG. 11 is a plot of resistance bias distribution comparing a current site investigation plan (CSIP) to the ESIP incorporated into a pile design according to at least one embodiment of the present disclosure.

FIG. 12 is a flowchart of an ESIP algorithm for bridge design considering both geological and ground uncertainties according to at least one embodiment of the present disclosure.

FIG. 13 is a pictorial explanation of recommended borehole selection for ESIP according to at least one embodiment of the present disclosure.

FIG. 14 is a scree plot of actual and recommended boreholes utilized to select an estimated number of boreholes according to at least one embodiment of the present disclosure.

FIG. 15 shows eight boreholes at a bridge site according to at least one embodiment of the present disclosure.

FIG. 16 shows the 46 standard penetration test (SPT) values in four geomaterial layers as sampled from the four drilled holes in proximity to the foundation locations of a study site according to at least one embodiment of the present disclosure.

FIGS. 17A-17D show model comparisons in the different geomaterial layers according to at least one embodiment of the present disclosure.

FIG. 18 is an accuracy plot showing the bias distribution and root mean squared error (RMSE) values for cross validation of two models (PUGU and PU) according to at least one embodiment of the present disclosure.

FIG. 19 shows z-direction (depth) transiogram estimated from example data according to at least one embodiment of the present disclosure.

FIG. 20 is a 3D simulated subsurface plot showing predicted geological property according to at least one embodiment of the present disclosure.

FIG. 21 is an isotropic variogram of an exponential spatial correlation for SPT N-values according to at least one embodiment of the present disclosure.

FIG. 22A is a 3D simulated subsurface showing log-transformed predicted SPT N-values according to at least one embodiment of the present disclosure.

FIG. 22B is a 3D simulated subsurface showing back-transformed predicted SPT N-values according to at least one embodiment of the present disclosure.

FIG. 23A shows relative borehole drilling locations for an Iowa Department of Transportation (IADOT) sampling plan according to at least one embodiment of the present disclosure.

FIG. 23B shows relative borehole drilling locations for a conditional simulation proposed sampling plan according to at least one embodiment of the present disclosure.

FIG. 24A shows data for uncertainties in the four geomaterial layers as obtained from the IADOT sampling plan according to at least one embodiment of the present disclosure.

FIG. 24B shows data for uncertainties in the four geomaterial layers as conditional simulation proposed sampling plan according to at least one embodiment of the present disclosure.

FIG. 25 shows a comparison between sampled borehole geological properties from the actual and ESIP boreholes according to at least one embodiment of the present disclosure.

FIG. 26 shows validation data for ESIP compared to actual borehole data according to at least one embodiment of the present disclosure.

Figures included herein illustrate various embodiments of the disclosure. It is contemplated that elements and features of one embodiment may be beneficially incorporated in other embodiments without further recitation.

### DETAILED DESCRIPTION

Embodiments of the present disclosure generally relate to methods of developing a site plan, and more specifically to geostatistical methods for developing a site plan. Embodiments of the present disclosure are also related to improving the design and construction of pile foundation systems. Unlike conventional methods, embodiments described herein can take into account geological uncertainties and ground uncertainties. Further, and unlike conventional methods, embodiments described herein are efficient, cost-effective, and reliable. Moreover, embodiments described herein can produce site plans with a high degree of confidence in, for example, soil selection. Embodiments of the present disclosure can be utilized in various applications including, but not limited to, pile designs for highway bridges, buildings, and civil infrastructures.

Conventional methods for site plans typically involve gridding out a surface and taking core samples to determine properties of the soil. The core samples are then used to triangulate a location to drill a borehole. Not only are conventional methods expensive due to the costs associated with core samples, but the lack of core samples also taken leads to unreliable site plans. For example, an engineer may want a hundred or so core samples to determine an appropriate site for drilling a borehole. However, conventional methods for site plans rely on only ten core samples to determine the appropriate site. Hence, the data given to an engineer is not plentiful and may be unreliable.

The inventors have found methods for developing site plans that are improved over conventional methods. In the above example where an engineer would receive ten or so core samples, these ten or so core samples can be used with embodiments described herein to determine an improved site plan relative to the state-of-the-art.

The use of headings is for purposes of convenience only and does not limit the scope of the present disclosure. Embodiments described herein can be combined with other embodiments.

Embodiments of the methods described herein can utilize an algorithm to develop a site plan that engineers can rely on with a higher degree of confidence than those state-of-the-art site plans.

In some embodiments, load and resistance factor design (LRFD) is utilized. LRFD is a probabilistic design philosophy that incorporates uncertainties and the associated risks into pile design. With the quantification and minimization of uncertainties through an example site investigation plan (ESIP), a resistance prediction and pile design can be obtained that is improved over conventional technologies (e.g., current site investigation plans (CSIP)).

As used herein, the terms “current site investigation”, “current site investigation plan”, and “CSIP” refer to conventional methods unless specified to the contrary or the context clearly indicates otherwise.

As used herein, and unless specified to the contrary, the terms “example site investigation”, “example site investigation plan” and “ESIP” refer to embodiments of the present disclosure.

As used herein 1 foot (ft)≈0.3048 meters; 1 kilo-pound per square foot (ksf) or kips/ft²≈0.0479 Megapascal (MPa); “kips” is a U.S. customary unit of force.

As used in equations herein, “Π” is a product operator, “Σ” is a sum operator, “log” is logarithm, and “exp” is exponentiation unless specified to the contrary or the context clearly indicates otherwise.

Site investigation is an important aspect of any geotechnical design. Two main classes of geomaterial-related information can be obtainable from the sampling aspect of site investigation, namely (1) the geomaterial type (geological property) where the data includes a categorical geomaterial classification and (2) the geomaterial property (ground property) where the data includes a quantitative geotechnical response. Embodiments of the present disclosure include the specification of these two uncertainties related to geological property and ground property.

As used herein, the term “geological property” includes, but is not limited to, properties such as the type of geomaterial, such as, for example, clay, sand, till, shale, weathered shale, silt, gravel, or combinations thereof, among others. “Geological property” and “geomaterial type” are used interchangeably unless specified to the contrary or the context clearly indicates otherwise.

Uncertainties related to geological properties are included in “geological uncertainty”. Geological uncertainty includes the changeability due to one geomaterial embedded in another, such as at the boundaries between different geomaterial layers.

As used herein, the term “ground property” includes, but is not limited to, a characteristic of the geomaterial such as a mechanical property, a physical property, a thermal property, or combinations thereof, among others. Ground properties can include, but are not limited to, color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof, among others. “Ground property” and “geomaterial property” are used interchangeably unless specified to the contrary or the context clearly indicates otherwise.

Uncertainties related to ground properties are included in “ground uncertainty”. Ground uncertainty includes uncertainty due to the prediction of a ground property at the unsampled location of the site. It can be closely related to inherent variability which is the difference between a ground property from one spatial location to another.

ESIPs described herein can include reducing both forms of uncertainties geological uncertainty and ground uncertainty. An ESIP obtained from the analysis of both forms of uncertainties can result in a better prediction of the geological property and ground property for pile foundation design. In some embodiments, the influence of geological uncertainty can be integrated into a spatial modeling of ground uncertainty to aid in engineering decision-making. Accurate characterization of the geomaterial boundaries using probabilistic tools can result in a better evaluation of pile bridge design, slope reliability and landslide stability.

Another difficulty in the geotechnical characterization of a site is the determination of the estimated number and location of boreholes for a bridge project. In conducting a site investigation, various parameters are probed, for example, the depth of the borehole(s), the number of drilled boreholes that are sufficient for the desired task, and the location of the boreholes to be drilled. In practice, site investigation plans are based on budget, local experience, or procedures specified by codes. For example in the United States, AASHTO specifies a minimum of two boreholes per bridge pier or abutment for a bridge with a width greater than 100 ft. In Australia, the recommendation of a borehole at every 100 feet (ft) is specified by the Austroads Bridge Design Code. The summary of these open-ended design codes is a specification of uniformly spaced boreholes that are not directly based upon uncertainty or cost-efficiency. A site investigation plan based on the design code, or one determined empirically on time, budget, and experience can be inefficient because it does not account for prior information from the specific project site. For example, an estimated number of boreholes on site A might be inappropriate or drilled at the wrong locations for site B. Hence, site-specific determination of the estimated number and location of boreholes for the bridge pile design remains a largely unsolved problem.

Embodiments described herein can, for example, solve these and other challenges by, for example, interpolating the subsurface stratigraphy and predicting ground property of interest from sparse actual preliminary borehole data, determining (e.g., quantifying) the geological property and ground property uncertainties in the multilayered site, and implementing a procedure to plan the borehole layout that will reduce these uncertainties for site investigation. Embodiments of the present disclosure can utilize random fields to obtain multiple simulations based upon, for example, universal kriging (UK) to predict the geomaterial property (ground property) and/or multinomial categorical prediction (MCP) based upon spatial Markov Chains (spMC) to predict the geomaterial type (geological property). The predictions and their uncertainties quantified in terms of standard deviation (SD) can be used in determining an ESIP.

Embodiments can involve one or more of the following non-limiting operations, among others: (1) Three-dimensional (3D) analysis of sparse actual borehole data can be utilized to accurately reflect the project subsurface condition. (2) Geological uncertainty can be incorporated into the analysis through refined geomaterial layer boundaries such that all resulting layers can be analyzed with different geomaterial means. By combining the layers this way, it can be possible to gain information on the spatial structure of the whole subsurface while also improving ground property prediction at the unsampled locations of the random field. The impact of incorporating geological uncertainty can be examined by comparing results to when its incorporation is ignored. (3) The ESIP can be determined to reduce geological and ground uncertainties through the analysis of boreholes within the proximity of the pile foundation. Subsequent borehole locations can be selected to reduce the SD of the predicted ground property. The process can be repeated until the reduction effect is minimal and not worth the cost of the additional borehole.

A general concept behind ESIP described herein is that of a multiphase site investigation, whereby the minimum boreholes can be drilled in the preliminary site investigation and the recommended boreholes can be drilled in the subsequent detailed site investigation.

It can be challenging to directly ascertain the geological property(ies) and the ground property(ies) throughout the whole study site based on limited borehole data. However, embodiments described herein can include utilizing a random field to predict unknown geological property(ies) and unknown ground property(ies) at unsampled locations. The predictions and their quantified uncertainties can be reduced through the determination of ESIP. Hence, and in some embodiments, a plan (which includes the number and location of boreholes) can be considered improved if it minimizes the uncertainties with a reasonable site investigation cost to achieve an efficient bridge design.

As used herein, the term “unknown” includes aspects of a site or a random field being modeled that are not precisely known. This includes unknown spatial distributions of a property or any other suitable part of the random field that is not fully understood or sampled. For example, an unknown can refer to an unknown location and/or an unknown property. By performing simulations that account for these unknowns, the resulting range of outcomes effectively quantifies the uncertainty. “Uncertainty” includes the quantification of the potential variability in the model outputs due to the unknowns. It includes the range of possible outcomes that could arise from the inherent unknowns in the system Therefore, while unknowns are the source, uncertainty is the effect of modeling and simulation. In this context, the uncertainty (ies) refers to geological uncertainty and ground uncertainty.

“Unsampled” refers to a spatial location in a random field with an unknown property (geological or ground).

Site investigations can be important in characterizing the geomaterial and ground profile for the design of bridge pile foundations. A site investigation plan can be conducted to maximize geomaterial information and minimize uncertainty. However, conventional site investigations are deficient for many reasons including their inability to properly account for uncertainties. For example, uncertainties exist in choosing the estimated number and location of boreholes in a multiphase site investigation plan. This choice can be further complicated by geological uncertainties and ground uncertainties.

Embodiments described herein can solve these challenges by, for example, utilizing a multinomial categorical prediction and universal kriging on a random field with multiple simulations. Embodiments of the present disclosure can, for example, yield a lower prediction error, can improve the prediction of geological property (geomaterial type) and ground property (geomaterial property), and can reduce the subsurface uncertainties. Overall, the incorporation of a site investigation plan described herein can improve the design efficiency and performance of pile foundations.

### Example Methodology

As described herein, it is challenging to directly ascertain geological property(ies) and ground property(ies) throughout a whole study site based on limited borehole data. As described herein, a random field can be utilized to predict these geological property(ies) and ground property(ies) at unsampled locations. The predictions and their quantified uncertainties can be reduced through the determination of an ESIP that includes the number and location of boreholes. Unlike conventional methods, embodiments described herein can utilize the application of geostatistical methods for the combined analysis of both geological and ground uncertainties to determine ESIP. This section provides a non-limiting mathematical framework for an ESIP.

### Geological Uncertainty

For a discretized grid on a random field, Z(s) is a categorical random variable for a geomaterial type (geological property) at a spatial location, s. Another spatial location is s+h, where h is the multidimensional lag and ∥h∥ is the Euclidean distance between s and s+h. With these parameters, a transition probability, tᵢⱼ(h), of going from geological property zᵢ to another geological property zⱼ can be determined by Equation 1:

tᵢⱼ(h)=Pr(Z(s+h)=zⱼ|Z(s)=zᵢ) (Equation 1)

wherein: Pr is probability; Z(s) is a categorical random variable for a geological property at a spatial location, s; Z(s+h) is a categorical random variable for a geological property at another spatial location, S+h; i and j are geological property indexes, where i, j=1, 2, . . . , nₛ; and nₛ is the number of geological property(ies) (such as layer(s)).

The collection of transition probabilities tᵢⱼ(h) in Equation 1 across all i, j can be determined by the nₛ×nₛ transition probability matrix, T(h), as shown in Equation 2:

T(h)=exp(∥h∥Rₕ) (Equation 2)

wherein: Rₕ is a transition rate matrix which depends on the direction given by the lag h; and ∥h∥ is the Euclidean distance between s and s+h. The random process of the continuous-time Markov chain can change from one geological property to another according to the exponential function and as specified by the probabilities in the transition matrix.

The transition rate matrix, Rₕ, in Equation 2 can be expressed as shown in Equation 3:

Rₑ_{ₖ}=diag({L̅_{i,e}_{ₖ}})⁻¹(Fₑ_{ₖ}−I) (Equation 3)

wherein: Rₑ_{ₖ} is elements of the transition rate matrix, Rₕ; k=1, 2, . . . , d for d dimensions; eₖ is a standard basis vector for the direction indexed by k; L̅_{i,e}_{ₖ} is the mean stratum thicknesses of the geological property i along the direction eₖ; diag denotes a diagonal matrix with entries L̅_{i,e}_{ₖ}; Fₑ_{ₖ} is a transition probability matrix that includes probabilities for consecutive grids with the same geological property along the direction eₖ; and I is an identity matrix.

The transition rate, r_{ij,h}, in row i and column j of the transition rate matrix Rₕ in Equation 2 can be calculated as shown in Equation 4:

$$\vert {r}_{i j , h} \vert = {[ {\sum }_{k = 1}^{d} {( \frac{{h}_{k}}{‖ h ‖} {r}_{i j , {e}_{k}} )}^{2} ]}^{1 / 2} \qquad ( Equation 4 )$$

wherein r_{ij,e}_{ₖ} denotes row i and column j of Rₑ_{ₖ} in Equation 3; r_{ij,h} is non-positive when i=j and r_{ij,h} is non-negative when i≠j; and hₖ is k^{th} components of the vector h.

To determine or predict an unknown geological property at an unsampled spatial location (s₀), an approximation of a conditional probability of the unknown geological property using multinomial categorical prediction in Equation 5 can be performed according to Equation 5:

$${q}_{j} ( {s}_{0} ) \approx \frac{{p}_{i} {\prod }_{l = 1}^{n} {t}_{i {k}_{l}} ( {s}_{0} - {s}_{l} )}{{\sum }_{i = 1}^{{n}_{S}} {p}_{i} {\prod }_{l = 1}^{n} {t}_{i {k}_{l}} ( {s}_{0} - {s}_{l} )} \qquad ( Equation 5 )$$

wherein: qⱼ(s₀) is the conditional probability of the random field at the unsampled spatial location (s₀); pᵢ is a proportion of an i^{th} category of the unknown geological property in the random field; n is a number of spatial locations in the random field; l is a sampled spatial location index of the random field; nₛ is a number of different geological properties in the random field; i is a geological property index of n and nₛ; and tᵢₖ_{ₗ}(s₀−sₗ) represents a transition probability as defined in Equation 1 from geological property zᵢ to another zₖ for observation with index l. The random field (e.g., predicted subsurface) comes from the MCP and the MCP is used in predicting the geological property.

A plurality of Monte Carlo simulations can then be performed on the conditional probability of the random field (e.g., the predicted subsurface) to propagate the conditional probability. In some embodiments, there is a single prediction before the subsequent plurality of Monte Carlo simulations. The average of the Monte Carlo simulations of the conditional probability of the random field can be taken and the unknown geological property for each spatial location of the random field is predicted as the geological property with the highest conditional probability.

The conditional probabilities over the plurality of Monte Carlo simulations at each spatial location can then be converted to information entropy to determine (e.g., quantify) the geological uncertainty. For example, a randomized simulation, Hₘ(s₀), calculated at a spatial location s₀ using an approximation of the conditional probability q_{j,m}(s₀) in Equation 5 for one simulation indexed by m out of the multiple Monte Carlo simulations n_{M}, the corresponding equation can be given by Equation 6:

$${H}_{m} ( {s}_{0} ) = - {\sum }_{j = 1}^{{n}_{s}} {q}_{j , m} ( {s}_{0} ) {log}_{{n}_{s}} {q}_{j , m} ( {s}_{0} ) \qquad ( Equation 6 )$$

wherein: Hₘ(s₀) is information entropy of the unknown geological property at the unsampled spatial location in one Monte Carlo simulation indexed by m of the plurality of Monte Carlo simulations; nₛ is a number of different geological properties in the random field; j in g_{j,m} is an index for the different geological properties; m in g_{j,m} is an index for the Monte Carlo simulation; g_{j,m}(s₀) is qⱼ(s₀) of Equation 5 for one Monte Carlo simulation indexed by m of the plurality of Monte Carlo simulations. Geological uncertainty is determined (e.g., quantified) from Equation 6 by determining a location average information entropy, H̅(s₀) as shown in Equation 7:

$$\overline{H} ( {s}_{0} ) = \frac{\sum {H}_{m} ( {s}_{0} )}{{n}_{M}} \qquad ( Equation 7 )$$

wherein: H̅(s₀) is the location average information entropy at the unsampled spatial location; and n_{M} is the total number of Monte Carlo simulations of the plurality of Monte Carlo simulations.

The location average information entropy can be obtained at a spatial location by taking the mean of the information entropy values in Equation 6 summed across nₛ which is the number of the different geological properties. The logarithm can be taken at a base equal to the number of the different geological properties. From the determination (e.g., quantification) of geological uncertainty, the stratigraphic boundaries can be evaluated as continuous spatial locations with high values of mean information entropy.

### Ground Uncertainty

A process of analyzing geomaterial property (ground property) uncertainty can be carried out for each simulation of the geomaterial layer boundaries described above with respect to geological uncertainty.

Consider a random variable of a ground property (Y) where the covariance matrix of that ground property is C(Y)=Σ. The covariance matrix, Σ, can be used to account for a spatial correlation structure. A spatial correlation function is specified via H(ρ) as shown in Equation 8:

Σ=σ²H(ρ) (Equation 8)

wherein: H(ρ) is a spatial correlation function; p represents a range parameter; and σ² represents a partial sill.

In a non-limiting example, an exponential correlation function for H(ρ) that can be utilized is given in Equation 9:

H(ρ)=exp(−h/ρ) (Equation 9)

wherein h is a Euclidean distance.

To predict the ground property at the unsampled spatial location (s₀), a linear unbiased prediction for universal kriging can be utilized and is given by:

$$\hat{y} ( {s}_{0} ) = {\underline{x} ( {s}_{0} )}^{′} \underline{\hat{β}} + \underline{{\hat{v}}^{′}} {\hat{\sum }}^{- 1} ( y ( s ) - X \underline{\hat{β}} ) \qquad ( Equation 10 )$$

wherein: ŷ(s₀) is the predicted (or estimated) unknown ground property at the unsampled spatial location (e.g., ŷ(s₀) is a prediction or estimation of the unknown ground property); s is a sampled spatial location; s₀ is an unsampled spatial location with an unknown ground property to be predicted; x(s₀)′ is a value of a design matrix for the unknown ground property at s₀; \hat{β} in each instance is a regression coefficient vector of the unknown ground property predicted using generalized least squares; \hat{v}′ is a vector of covariances of the known ground property with entries [symbol] (Y(s₀), Y(sᵢ)) for i=1, . . . , n; \hat{Σ}=²H(\hat{ρ}) is a restricted maximum likelihood estimate of a covariance matrix Σ; y(s) is a value of the known ground property at s; and X\hat{β} is X multiplied by \hat{β}, where X is a design matrix that contains covariate values for the known ground property at all sampled locations.

A plurality of conditional simulations can then be conducted on the ground properties predicted based on the geological property predicted (as described above) to account for the uncertainties associated with plug-in estimates used to perform universal kriging. Here, the ŷ(s₀) value determined in Equation 10 can be conditionally simulated to produce a predicted ground property ŷᵢ in plurality of the Monte Carlo simulations n_{M}. The term “plug-in estimates” includes estimates used in prediction for kriging before conditional simulation. These estimates can be utilized to account for uncertainties in the simulation of random fields, which are based on sampled data and their spatial structures. The simulation can produce realizations that match the data at the sampled locations by working with the conditional distribution given by the data. In this way, the uncertainties in both the geological property (geomaterial type) and the ground property (geomaterial property) estimates and their responses can be maintained and simultaneously propagated into additional analyses involving a pile design.

It is noted that the number of conditional simulations is equivalent to the number of Monte Carlo simulations.

The combined geological and ground uncertainties are determined (e.g., quantified) by a standard deviation (SD) given in Equation 11:

$$S D = \frac{1}{{n}_{M} - 1} {\sum }_{i = 1}^{{n}_{M}} {( {\hat{y}}_{i} - \overline{\hat{y}} )}^{2} \qquad ( Equation 11 )$$

wherein: SD is the standard deviation at the unsampled spatial location; n_{M} is the number of simulations; i indexes each simulation; ŷᵢ is the predicted ground property value for simulation i and \hat{y̅} is the sample mean of the predicted ground property values for each conditional simulation. The term “combined geological and ground uncertainties” captures uncertainties in both geological formations and ground properties. The SD value obtained by Equation 11 is also a standard deviation of the predicted ground property because it incorporates the unknown geological property.

The geological uncertainty and the combined geological and ground uncertainties can be quantified using Equation 7 and Equation 11, respectively. These uncertainties can be used in an algorithm to obtain an ESIP. The ESIP can be used to determine borehole selection. Both geological and ground uncertainties are utilized for determining the ground uncertainty in order to, for example, ensure an accurate estimate of the ground uncertainty.

### Example Site Investigation Plan (ESIP)

Generally, and in some embodiments, a method of determining an ESIP includes one or more of the following operations:
(1) Inputting geological data (geological property data) and ground data (ground property data) from actual boreholes (initial boreholes), and their locations, into an algorithm. The actual boreholes can be boreholes that are drilled in proximity to pile foundations during an initial site investigation.
(2) Defining and/or discretizing the initial test site or a random field. The actual/initial test site is termed random field during the analysis.
(3) Characterizing the random field by predicting the geological property(ies) and ground property(ies) at unsampled locations of the random field.
(4) Specifying the number of simulations, such as Monte Carlo simulations, to be performed on the random field to propagate its uncertainties. The number of simulations can be selected based on whether further simulations produce more than a marginal change in the uncertainty value. More than a marginal change can be more than ±1%.
(5) After application of the initial borehole data to multiple random fields, statistical summaries are obtained and uncertainties are quantified. In some examples, uncertainties are quantified through standard deviation (SD).
(6) Recommending a subsequent borehole to be added to the initial/actual boreholes and/or to boreholes from a CSIP at an x-y location that decreases the SD the most within the random field. The initial borehole data can be updated with the recommended borehole and can be reapplied to the multiple simulated random fields. A subsequent borehole can be again recommended to be added to the boreholes at the x-y location that decreases the SD the most.
(7) Operation (6) is repeated until the estimated number of initial (actual) boreholes and recommended boreholes is obtained. The estimated number of initial and recommended boreholes is the number where an additional subsequent borehole has minimal or no effect on the SD of the combination of initial and recommended boreholes on the random field. For example, the estimated number can be determined when, for example, there is minimal or no further reduction in the geomaterial uncertainties, measured in terms of SD, or where additional recommended boreholes are no longer cost-effective, or combinations thereof.
(8) Drilling the estimated number of boreholes at their grid locations to re-simulate the geomaterial properties (the geological properties and the ground properties). The drilling here can be part of a detailed site investigation.

In some examples, the concept of a multiphase site investigation (SI) can be applied to the method, where the initial boreholes are drilled at the pile foundation locations in the preliminary SI phase (the initial site investigation phase in operation (1)), and the recommended boreholes can be drilled in the subsequent detailed SI phase after geostatistical analysis (the detailed site investigation in operation (8)).

As described above, an ESIP algorithm can be utilized to determine the borehole selection. The ESIP algorithm can be implemented into an R program and implemented with a computer. Various R packages such as (R:expand grid), (R:multi_tpfit), (R:sim_mcs), (R:lme[nlme], gls[nlme,likfit]), (R:fit.variogram.reml[gstat]), (R:krige[gstat]), or combinations thereof, among others, can be utilized in the R program that implements algorithms described herein. The R packages, in R programming language, are a set of R functions, compiled code, and sample data. R functions can be used when performing a certain task multiple times. The R function accepts input arguments and produces the output by executing R commands that are inside the function.

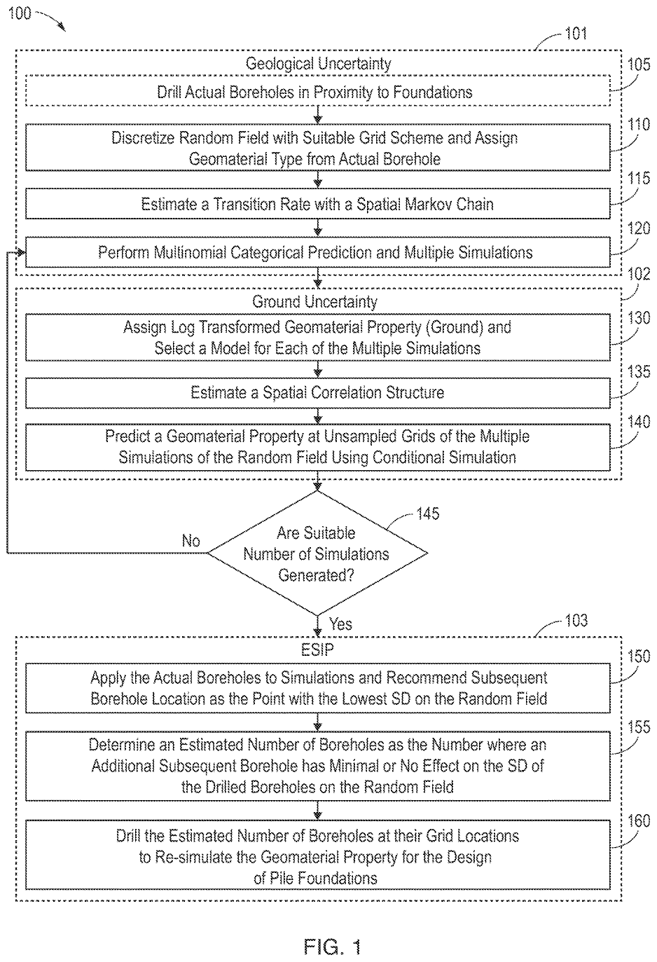

FIG. 1 is a flowchart showing selected operations of a method 100 for developing a site plan according to at least one embodiment of the present disclosure. The method 100 is an algorithm to determine an ESIP for a pile design through a combined analysis of geological uncertainty (stage 101) and ground uncertainty (stage 102). The algorithm can be implemented in an R program as described above. Inputs utilized for the algorithm can include, but are not limited to, a three-dimensional (3D) random field measurement, transverse-longitudinal coordinates of the boreholes, the sampled geological property, the ground property of interest at each subsurface depth examined, or combinations thereof. Such inputs can be collected from the drilled boreholes and the site plan. Additionally, or alternatively, and in at least one embodiment, such inputs can be collected from a CSIP that contains the initial/actual boreholes.

ESIP (stage 103)—dashed box around operations 150, 155, and 160), —in the context of FIG. 1, is the process of recommending additional boreholes to the CSIP or to the initial boreholes on the site to reduce the unknowns and uncertainties.

With respect to geological uncertainty (stage 101), the method 100 includes performing a preliminary site investigation at operation 105 where actual boreholes (initial boreholes) are drilled in proximity to pile foundations. This known geological property data and ground property data from these actual boreholes, and their location coordinates, can be entered into the algorithm at operation 110 and operation 130, respectively.

In some embodiments, a CSIP can be incorporated into a pile design. Although CSIP is a method, CSIP can additionally refer to the actual (initial) boreholes drilled on the site as CSIP is also a site investigation plan that contains the initial boreholes. CSIP data, e.g., CSIP boreholes, can be incorporated into a pile design by, for example, converting a ground property shown through the borehole into pile resistance for the design of the pile.

The method 100 can further include, at operation 110, discretizing a relevant domain (or random field) with a suitable grid scheme and assigning the geological property (geomaterial type) from the actual borehole data to the corresponding grid location. In operation 110, and as an example, the size of the test site (a relevant domain) or size of the random field can be defined and discretized into several 3D grids. The geological property data gathered from the actual boreholes drilled can be assigned to the corresponding grid location. This geological property information can be conditional for the prediction of the geological property and for quantifying the geological uncertainty. Operation 110 can include utilizing the R package (R:expand grid). The R:expand grid function returns a data frame that contains a row for each combination of supplied vectors or factors. A non-limiting purpose of operation 110 is for accurate data integration, modeling, and visualizing subsurface geological uncertainty.

The method 100 can further include estimating a 3D transition rate(s) of the geological property and/or probability(ies) of a change in the geological property using spatial Markov chains based on the borehole data at operation 115. Spatial Markov chains (spMC), such as the Coupled Markov Chain (CMC) and the Markov Random Field (MRF), rely on the Markovian property for the subsurface domain to address the uncertainty arising from limited borehole data. The CMC extends one-dimensional Markov Chains to two dimensions to account for spatial structure using conditional probabilities. The MRF extends the CMC to allow for anisotropy (directionally dependent local correlations) and non-stationarity (local correlations that differ spatially. Estimation of the 3D transition rates and probabilities using spatial Markov chains at operation 115 is further described in the Examples Section. During operation 115, transition rates matrices along axial directions and proportions of categories can be computed. Operation 115 can include utilizing the R package (R:multi_tpfit) (Multidimensional Model Parameters Estimation). The R:multi_tpfit function estimates the model parameters of a 3D continuous lag spatial Markov chain. A non-limiting purpose of operation 115 is to quantify the frequency and likelihood of changes in geological states over time or space.

The method 100 can further include, at operation 120, performing a multinomial categorical prediction and multiple simulations. Operation 120 can include predicting geological property (geological properties) at unsampled locations of the discretized domain using a multinomial categorical prediction (MCP) and simulating geological uncertainty multiple times to generate a plurality of realizations. Each realization of the plurality of realizations is an image of a predicted subsurface that, e.g., delineates the subsurface stratigraphy. The discretized domain can be a discretized pile domain, a discretized bridge domain, or combinations thereof, among other suitable discretized domains. Operation 120 can include utilizing the R package (R:sim_mcs) (Multinomial Categorical Simulation, MCS, in spMC). The R:sim_mcs function simulates a random field through the MCP (also called MCS) technique. A non-limiting purpose of operation 120 is to accurately predict and analyze the spatial distribution of multiple geomaterial categories or classes (for example, soil and rock types) and to assess the uncertainty in these predictions by generating a range of possible scenarios through simulations. The geological uncertainty equation (Equation 7) can be utilized during operation 120.

In some embodiments, the method optionally includes describing (e.g., delineating and/or characterizing) the stratigraphic boundaries of each different realization as obtained from the multiple simulations of geological uncertainty in operation 120. The stratigraphic boundaries are described and the geological uncertainty data utilized to predict the geological property (geomaterial type) is completed. Here, the method can include setting out the ground property (geomaterial property) from the actual boreholes to the described geomaterial stratification of the discretized domain (not shown in FIG. 1). For example, the geological uncertainty can be transferred to the ground properties through the delineation of the geological or stratigraphic boundaries before the ground data integration into the random field in order to quantify both the geological uncertainty and the ground uncertainty. As an example, an uncertainty associated with clay (developed in stage 101) can be combined with the ground properties of the clay from the actual boreholes.

The method 100 can further include assigning a log transformed ground property (geomaterial property) and selecting a model (e.g., a spatial model, linear model, etc.) for each of the multiple simulations at operation 130. Here, the ground property from the actual boreholes drilled can be log transformed and assigned to the spatial locations or points of the random field. Log transformation is performed by taking the logarithm of the ground property values. It is typically done to normalize skewed data, stabilize variance, linearize relationships, and manage wide value ranges, thereby facilitating more effective statistical analysis and modeling.

Operation 130 can include utilizing the R package (R:lme[nlme]). The R package, R:lme[nlme](non-linear mixed-effects models) function fits a linear mixed-effects model and allows for nested random effects. Additionally, the R package, R:gls[nlme,likfit], can be utilized. The gls function in R's nlme package can be used for fitting linear models using generalized least squares (gls), estimating the unknown regression coefficients in the context of a generalized linear model (GLM). The likfit function, often found in geostatistical packages like geoR, can be employed for fitting variogram models to spatial data using likelihood methods and assessing their isotropy assumption. A non-limiting purpose of operation 130 is to determine the appropriate spatial correlation structure of the data, which is a prerequisite for accurate spatial predictions and simulations.

The method 100 can further include estimating a spatial correlation structure estimated based on actual borehole data at operation 135. Estimating a spatial correlation structure can involve collecting spatial data, analyzing its distribution, constructing and fitting a variogram to model spatial dependence (covariance), estimating model parameters (such as range, sill, and nugget describe the spatial structure of the data), and validating the model for accurate representation of spatial relationships. The covariance matrix, E, is a fundamental component in modeling and quantifying the spatial correlation structure, influencing both the estimation of spatial models and the accuracy of spatial predictions. The Spatial correlation structure can be estimated after the model fit. A non-limiting purpose of operation 135 is to understand and quantify the relationships between spatial data points, enhancing the accuracy and reliability of spatial predictions and analyses.

In an example of operations 130 and 135, the log transforming of the ground property of interest and the assigning of the log-transformed ground property of interest provides a plurality of spatial models. Of the plurality of spatial models, a suitable model is selected for each of the multiple simulations. The spatial model developed in operation 130 is then fit with a spatial correlation structure estimated in operation 135.

Operation 135 can include utilizing the R package (R:fit.variogram.reml[gstat]). R:fit.variogram.reml[gstat] function in R, as part of the ‘gstat’ package, is used for fitting variogram models to spatial data using Restricted Maximum Likelihood (REML). It provides unbiased estimates of spatial correlation for accurate geostatistical analyses and predictions.

The method 100 can further include predicting a ground property (geomaterial property) value(s) at unsampled locations/grids of the random field using a conditional simulation at operation 140. Here, and in some embodiments, predicting can be performed using universal kriging. Operation 140 can include utilizing the R package (R:krige[gstat]). The R:krige[gstat] function in R performs kriging, a method of spatial interpolation that uses a model of spatial autocorrelation (described by a variogram), using various kriging methods (ordinary kriging, universal kriging, and simple kriging) to predict values at unsampled locations based on observed data. Universal kriging is a geostatistical method for spatial interpolation that allows spatially varying means, making it ideal for analyzing non-stationary spatial data with systematic variations over space, unlike simple or ordinary kriging which assumes a constant mean. Equation 10 can be utilized to predict the ground property at the unsampled spatial location. The ground uncertainty equation can be utilized during operation 140. At this stage, the prediction of the ground property at the unsampled location of the random field (subsurface) is completed.

After predicting the ground properties containing the geological uncertainty, the combination of geological and ground uncertainties is conditionally simulated.

The method 100 can further include, at operation 145, repeating operations 120-140 until a suitable number of simulations to be performed on the random field are generated. Here, operations 120-140 can be repeated for each realization generated in operation 120. These operations can be repeated, for example, until an additional simulation produces less than ±1% change in the ground uncertainty value. The answer at operation 145 can be “yes” if it the additional simulation produces less than ±1% change in the ground uncertainty value and no if the additional simulation produces more than 11% change in the ground uncertainty value. As described herein, the ground uncertainty incorporates the geological uncertainty. To the inventors' knowledge, this incorporation of geological uncertainty into ground uncertainty has not been utilized in conventional methods.

Reasons for generating a number of simulations include quantifying uncertainty, testing model robustness, and exploring various scenarios. The simulations performed on the random field propagate the uncertainties by generating a range of possible outcomes based on the statistical characteristics of the field, thus reflecting the inherent variability and unknowns in the spatial data. This approach allows for the visualization and quantification of how uncertainties in the input data and model assumptions affect the predictions and conclusions drawn from the model.

In simulations, these unknowns (e.g., aspects of the random field being modeled that are not precisely known) are the source of uncertainty. By performing simulations that account for these unknowns, the resulting range of outcomes effectively quantifies the uncertainty. Therefore, while unknowns are the source or cause, uncertainty is the effect or manifestation in the context of modeling and simulation.

When the suitable number of simulations are generated, the method 100 continues with operation 150. At operation 150, the method includes applying the actual boreholes (initial boreholes) to simulations and recommending a subsequent borehole location.

Operation 150 can include applying the actual boreholes to the multiple simulated random fields in order to, for example, obtain statistical summaries and to quantify uncertainties. The uncertainties can be quantified through a mean and/or a standard deviation (SD).

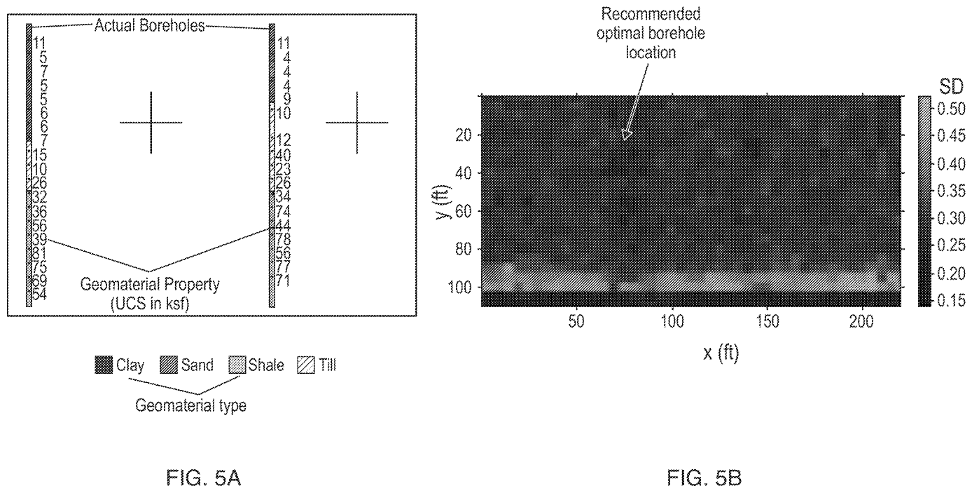

The sample means and SDs for each geological property can be summarized across all conditional simulations and sampling locations of the actual boreholes. The mean and/or the SD is then used in assessing the combined geological and ground uncertainties for a given site investigation plan. A subsequent borehole can be recommended to be added to the initial boreholes (actual boreholes) or to a CSIP at the x-y location that decreases the SD the most within the random field as shown in FIG. 5B. That is, the subsequent borehole location can be recommended as the point with the lowest SD on the random field. Operation 150 includes drilling (virtually) one or more recommended boreholes with the actual boreholes to provide a SD of how the one or more recommended boreholes will perform.

The method further includes determining an estimated number of boreholes as the number where an additional subsequent borehole has minimal or no effect on the SD of the combination of the actually drilled boreholes and virtually drilled boreholes on the random field at operation 155. The virtually drilled boreholes are the recommended additional boreholes. The estimated number can be determined when, for example, there is no further reduction in the geomaterial uncertainties (measured in terms of SD), where additional recommended boreholes are no longer cost-effective, or combinations thereof.

In some embodiments, the initial borehole data can be updated with the recommended borehole and can be reapplied to the multiple simulated random fields. A subsequent borehole can be again recommended to be added to the boreholes at the x-y location that decreases the SD the most. This process can be repeated until the estimated number of initial and recommended boreholes is obtained.

The method further includes, at operation 160 drilling the estimated number of boreholes at their grid locations to re-simulate and/or predict the ground property for the design of pile foundations. The drilling can be part of a detailed site investigation.

The concept of a multiphase site investigation (SI) can be applied to methods described herein (e.g., method 100), where the initial boreholes are drilled at the pile foundation locations in the preliminary SI phase (the preliminary site investigation phase in operation 105), and the recommended boreholes can be drilled in the subsequent detailed SI phase after geostatistical analysis (the detailed site investigation in operation 160).

The ESIP is based on the number of boreholes drilled in the preliminary site investigation (operation 105) combined with the boreholes recommended to be drilled in the subsequent detailed site investigation (operation 160).

In some embodiments, CSIP data from actual boreholes drilled on the site can be incorporated into a design by converting the ground property shown through the borehole into pile resistance for the design of the pile via, for example, Equation 12 (described below).

Embodiments described herein with respect to, for example, method 1200 can be utilized or combined with embodiments described with respect to, for example, method 100.

Embodiments of the present disclosure also relate to methods for generating a site investigation plan. The site investigation plan can be used for various implementation such as a pile design.

In some embodiments, the method for generating a site investigation plan for, e.g., a pile design, can include receiving input data. The input data can include data from actual boreholes such as a known geological property, a known ground property, or combinations thereof. Such input data can come from a preliminary site investigation. Additionally, or alternatively, the input data comprises data from a current site investigation plan. Here, for example, CSIP data from actual boreholes drilled on the site can be incorporated into pile design by converting the ground property shown through the borehole into pile resistance for the design of the pile via Equation 12 (described below).

Known geological properties can include a type of geomaterial, and the type of geomaterial can include clay, sand, till, shale, weathered shale, silt, gravel, or combinations thereof, among other suitable types of geomaterial. Known ground properties can include, but are not limited to, a characteristic of the geomaterial such as a mechanical property, a physical property, a thermal property, or combinations thereof, among others. The characteristic can include, but is not limited to, color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof, among other suitable characteristics of the geomaterial.

The method for generating the site plan for the pile design can further include performing a geostatistical prediction simulation on a random field (e.g., predicted subsurface) to determine or predict an unknown ground property at an unsampled pile location based on the input data. This unsampled pile location has a known pile location. This known pile location is a predetermined location where a pile is to be installed into the ground but has not yet been installed into the ground. At this known pile location, the geological property, the ground property, or combinations thereof may be unknown.

Various operations described herein, such as those described with respect to method 100 and/or method 1200 (among others) can be utilized in the method for generating the site investigation plan. For example, and in some embodiments, the performing the geostatistical prediction simulation on the random field to predict the unknown ground property at the unsampled pile location based on the input data can include performing simulations on the random field to propagate geological and ground uncertainties as described herein. As another example, and in some embodiments, after performing simulations on the random field to propagate geological and ground uncertainties, the method for generating the site plan for the pile design can further include placing virtual boreholes at locations on the random field to minimize the uncertainties propagated as described herein.

The method for generating the site plan for the pile design can further include using the predicted unknown ground property at the unsampled location that is simulated on the random field at the known pile location to determine whether the known pile location has a sufficient end-bearing resistance. In some embodiments, the method for generating the site plan for the pile design further includes designing the pile by predicting a unit end-bearing resistance of an H-pile. The predicting the unit end-bearing of the H-pile can be performed according to Equation 12:

$${\hat{q}}_{p} ( ksf ) = 45.72 {q}_{u}^{0.35} \qquad ( Equation 12 )$$

wherein: \hat{q}ₚ is the unit end-bearing resistance of the H-pile (in units of ksf); and qᵤ is a uniaxial compressive strength of shale (in units of ksf). Equation 12, and uses thereof, are further described in the Examples Section.

Any of the operations described herein, such as one or more of the operations of method 100, method 1200 (described below), and/or other operations of other methods described herein may be included as instructions in a computer-readable medium for execution by a control unit or any other processing system. The computer-readable medium may comprise any suitable memory for storing instructions, such as read-only memory (ROM), random access memory (RAM), flash memory, an electrically erasable programmable ROM (EEPROM), a compact disc ROM (CD-ROM), a floppy disk, and the like. The memory of the system can be coupled to a processor. The system can further include computer software instructions stored in the memory and executable by the processor, the computer software instructions comprising instructions for performing various operations described herein.

In another embodiment is provided a non-transitory computer-readable medium storing instructions that, when executed on a processor, perform one or more operations of any suitable method described herein. For example, non-transitory computer-readable medium storing instructions that, when executed on a processor, perform one or more operations of generating a site investigation plan, or for determining borehole selection, or for incorporating a site investigation plan into a pile design, or combinations thereof.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### EXAMPLES

### Example 1: Example Site Investigation Plan (ESIP)

### 1.1. Introduction

Example 1 is an illustrative, but non-limiting, ESIP according to at least one embodiment of the present disclosure. Example 1 demonstrates, for example, the improved resistance prediction and reliability for pile foundation in shales. Example 1 illustrates, for example: an algorithm for obtaining ESIP considering both the ground and geological uncertainties; geotechnical uncertainties are considered by using a prediction equation specific for H-piles driven into weathered shale; and the impact of using ESIP and geostatistical simulation on the predicted resistance and reliability of bridge pile foundations are quantified. An H-pile is a pile having an H-shaped cross-section.

The investigation presented in Example 1 was conducted using a database of 22 steel end-bearing H-piles driven into weathered shales and load tested in Kansas, Iowa, and Wyoming. The incorporation of ESIP into pile design by the non-limiting Example 1 can decrease the prediction error of end-bearing resistance by about 25.6% or more and can increase the load and resistance factor design (LRFD) for redundant piles by about 20% or more. This results in, for example, significant cost savings per foundation.

In this non-limiting example, site investigation can provide relevant subsurface information for the design of the pile foundation for bridges. Using multinomial categorical prediction (MCP) and conditional simulations on a random field, an ESIP is developed. The ESIP can minimize geological and ground uncertainties, can improve the design efficiency, and/or can increase economic benefits of the pile foundation.

Reliable static analysis (SA) methods for resistance prediction remain a challenge for piles driven into soft rocks or intermediate geomaterials (IGMs). For example, pile resistance predictions are often inaccurate due to geomaterial uncertainties. Embodiments described herein can improve the resistance prediction and reliability of H-piles driven into weathered rock-based shale by incorporating ESIP into a load and resistance factor design (LRFD).

LRFD is a reliability design philosophy that incorporates uncertainties and the associated risks into pile or geotechnical-structural design. One component of LRFD is site investigation. The resistance factors calibrated from LRFD can depend on the uncertainty and variability in the design ground property which can also depend on site investigation quality. Hence, site investigation can be an integral part of engineering projects to determine subsurface information relevant to the design of a foundation.

The CSIP—a conventional technique—which includes the actual (initial) boreholes drilled onsite is mainly based on local experience, construction timelines, budget, and standardized procedures specified in codes. Many state-of-the-art site investigation plans rely on reliability analysis whereby the design engineer looks for a conventional site investigation plan from the rest of the alternative plans that must be equidistant between acceptable and unacceptable reliability. However, these alternative site investigation plans are selected before the analysis making it difficult to determine a borehole location even when a target number of boreholes is determined. In addition, conventional practice in the design of bridge pile foundation is to use the information of the borehole in the nearest proximity to the pile from the CSIP. However, CSIP utilizes insufficient or inappropriate subsurface information on foundation designs, and CSIPs fail to yield adequate and accurate geomaterial resistance predictions for reliability design. In contrast, embodiments described herein can address this problem of incomplete geotechnical information by recommending boreholes at locations that will minimize geomaterial uncertainties.

In some embodiments, and to obtain an ESIP, incomplete data from actual boreholes (CSIP) on a site are analyzed with geostatistics using spatial patterns to predict the geological property and the ground property at unsampled locations of the site. Uncertainties propagated through multiple simulations can then be minimized by drilling and testing the ESIP recommended boreholes to improve the geotechnical-structural design. Embodiments of the present disclosure can be restricted to data obtained from site investigation administered before the geotechnical-structural design stage. Estimated numbers of boreholes can be selected where a reduction in geomaterial uncertainties will be insignificant even with additional boreholes.

In addition, embodiments of the present disclosure can also consider ESIP for H-piles driven into weathered shale. Weathered shale is a transitional geomaterial with a range of strength properties and shrink-swell potential. In some embodiments, weathered shale geomaterial is not treated as soil during pile design, otherwise, pile resistance could be under-predicted. An objective is to incorporate ESIP and geostatistical simulation into LRFD procedures to improve, for example, resistance prediction and design efficiency of H-piles driven into weathered rock-based shale.

Geostatistical analyses can be performed in three dimensions. LRFD can be conducted using Monte Carlo simulation on a load test database of twenty-two steel end-bearing H-piles driven into weathered shale in Kansas, Iowa, and Wyoming. Pile resistance can be restricted to the end-bearing resistance because it has an average 75% of the total resistance estimated by the load test. Each test pile foundation can have the subsurface, pile, and load test information.

### 1.2. Geostatistical Framework for Quantifying Geomaterial Uncertainties and Determining ESIP

Geomaterial uncertainties can include geological and ground uncertainties. These uncertainties, which can increase due to the weathering of shale, can be quantified using geostatistical methods described herein.

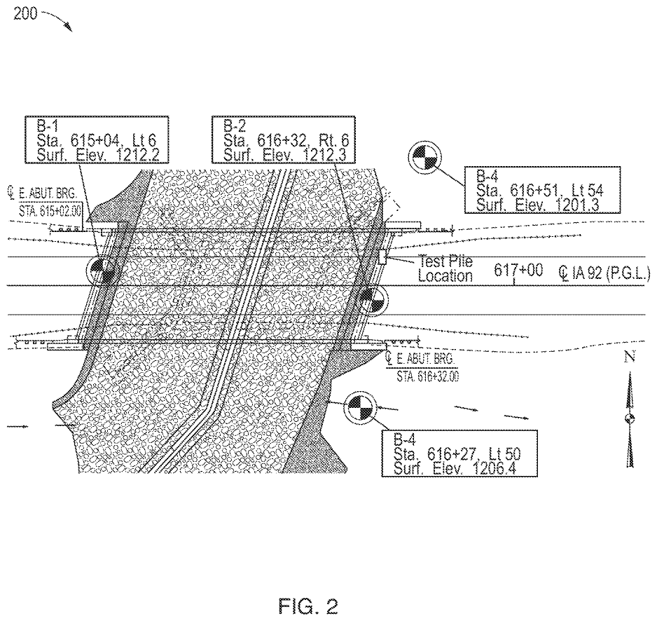

For this example, a bridge project site in Iowa, USA is used as a study site to describe the geostatistical framework for quantifying geomaterial uncertainties and determining ESIP. This is an example test site for demonstration purposes and does not limit the scope of the disclosure. The plan 200 of the study site showing the four drilled boreholes and the test pile location is shown in FIG. 2. Boreholes 1 (B-1) and 2 (B-2) are drilled at the west and east abutment foundations, respectively. Information from boreholes drilled in proximity to the foundation locations is recommended during pile design. The data to be used in the determination of ESIP can be restricted to the boreholes close to the foundation.

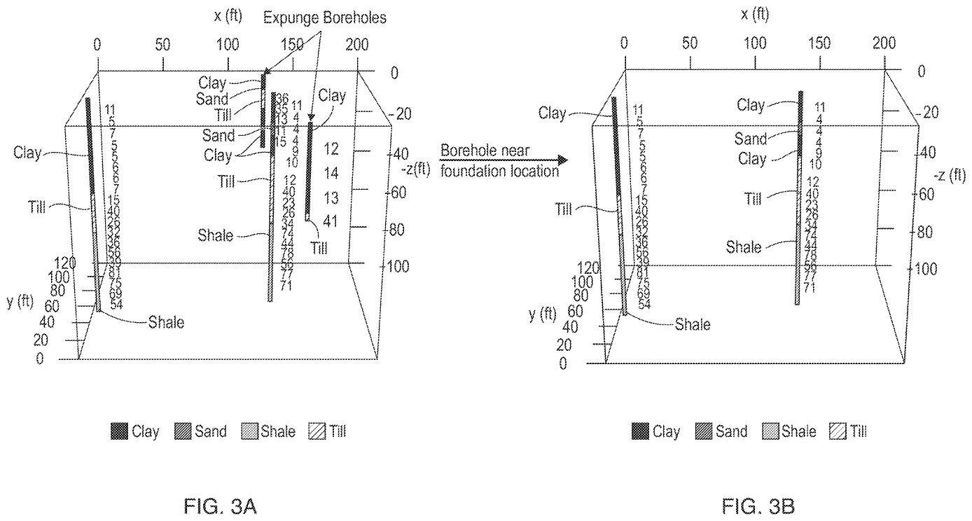

In this study site, two shallow boreholes in the three-dimensional (3D) plot of the borehole layout (FIG. 3A) can be removed because these boreholes are not drilled at the foundation location, and these boreholes will be used as the validation dataset. The 3D plot of the study site showing the geology and ground data after removing boreholes is shown in FIG. 3B and are referred to as a ‘random field’ or ‘subsurface’ in the present investigation. In FIGS. 3A and 3B, the x-axis is the longitudinal axis, the y-axis is the transverse axis, and the z-axis is the depth axis. The negative sign in the z-axis indicates depth below the ground surface. The actual boreholes includes clay, sand, till, and shale. In FIGS. 3A and 3B, the numbers to the right of the boreholes indicate refer to uniaxial compressive strength (UCS) in units of ksf.

### 1.2.1. Geological Uncertainties

For this investigation, input data used to quantify geological uncertainties and to improve the subsurface characterization of the site are the geological properties of clay, sand, till, and shale. Transition rates are estimated for all grid locations of the random field using this input data in FIG. 3B. Conditional probabilities between 0 and 1 are computed for all geological properties from the transition rates. The geological property with the highest conditional probability for each of the unsampled grid locations of the random field is predicted using multinomial categorical prediction (MCP). MCP, sometimes referred to as MCS, is a prediction and simulation method available in the spatial Markov Chain (spMC) package in R. The spMC is similar to the hybrid-evolution Markov chain Monte Carlo method used in estimating copula parameters. Multiple simulations are run on the random field with geological properties predicted at all its grid locations to propagate geological uncertainties. In the present example, a hundred (100) simulations are deemed sufficient.

### 1.2.2. Ground Uncertainties

For this investigation, input data used to quantify ground uncertainties and to improve the subsurface characterization of the site are the tested ground property (e.g., uniaxial compressive strength, qᵤ). Other geomaterial properties (ground properties) are contemplated. The ground input data in FIG. 3B is log-transformed and matched to each of the 100 simulations of a random field with geological properties predicted at all the grid locations. By simulating the ground properties this way, it is possible to improve the accuracy of the ground properties simulated at the unsampled grid locations and quantify both geological and ground (geomaterial) uncertainties.

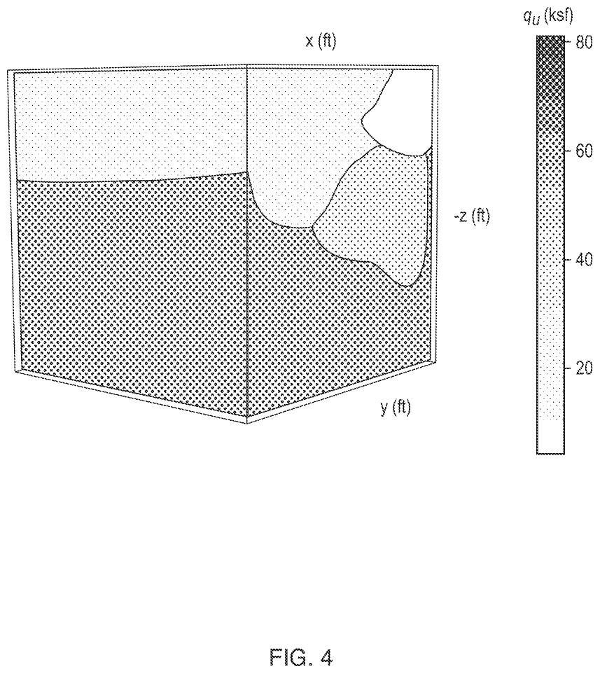

The simulated log qᵤ values are back-transformed to the original values. The conditional simulation used for some embodiments is found in the gstat package in R. A simulated subsurface indicating the geological layers and ground properties (qᵤ) for all grid locations is shown in FIG. 4. Referring to FIG. 4, geological and ground characterization of the random field was performed by predicting the geological property and ground property at the unsampled locations of the random field. The geological characterization is shown by the different shading in the subsurface plot in FIG. 4 and the ground characterization (qᵤ) is shown by the bar on the right-hand portion of FIG. 4.

### 1.2.3. ESIP Algorithm

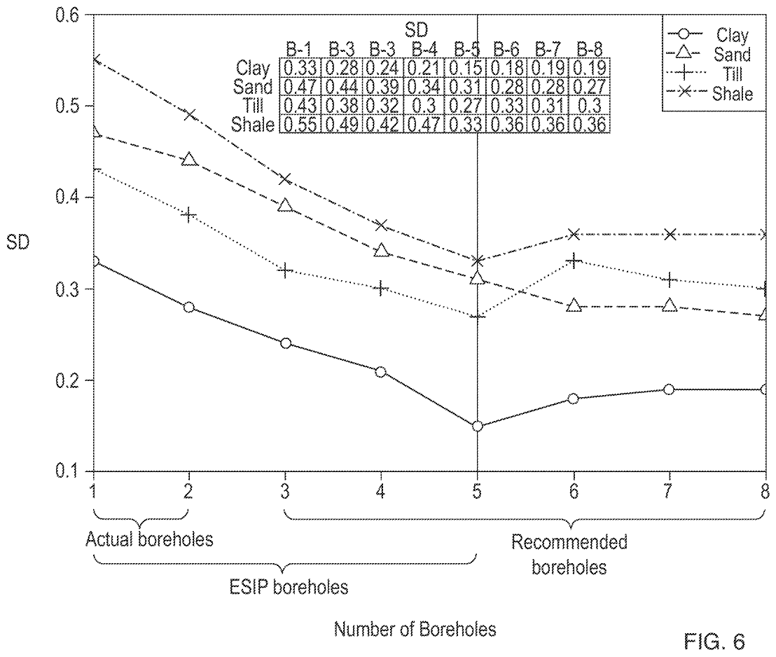

In this example, a summary of an example algorithm 100 to determine ESIP through the combined analysis of geological property and ground property uncertainties is shown in FIG. 1. After the application of the actual boreholes to the 100 simulated log-transformed qᵤ subsurfaces, its statistical summaries are estimated. Geomaterial uncertainties are quantified through the standard deviation (SD) of the log-transformed qᵤ. This SD on the log scale approximates the coefficient of variation (COV) on the original scale based on a Taylor series expansion. A subsequent borehole is recommended to be added to the actual boreholes or CSIP at the x-y location that decreases the SD the most within the random field as shown in FIGS. 5A and 5B. Because Example 1 is restricted to the end-bearing H-piles, the estimated location that most decreases SD (geomaterial uncertainties) on the bedrock (weathered shale) layer is chosen. The actual borehole data is updated with the recommended borehole and reapplied to the 100 simulated log-transformed qᵤ subsurfaces for its statistical summaries to be estimated. This process is repeated until the estimated number of actual and recommended boreholes is obtained. The estimated number of boreholes is determined, for example, when there is no further reduction in the geomaterial uncertainties in terms of SD, where additional recommended boreholes are no longer cost-effective, or combinations thereof, as shown in the scree plot in FIG. 6.

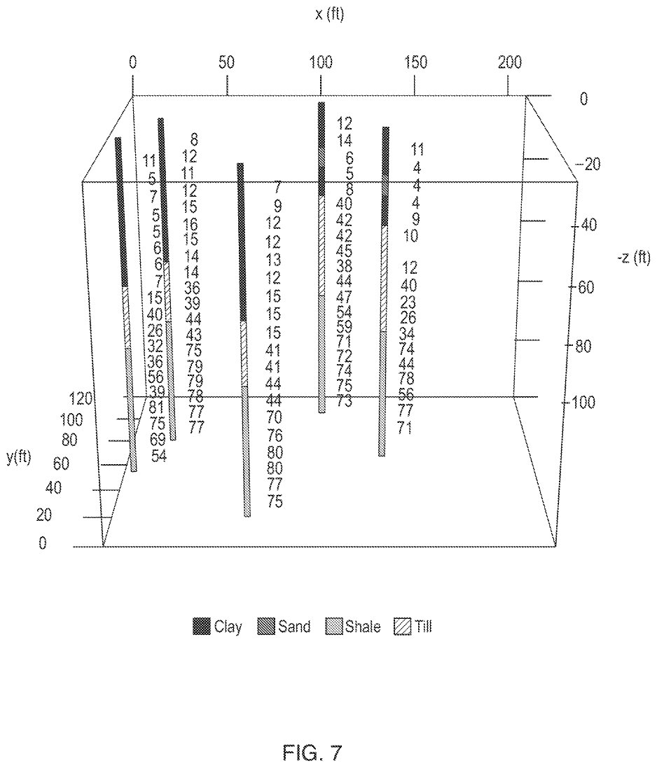

This study adapted the concept of multiphase site investigation where the actual boreholes are drilled at the pile foundation locations in the preliminary site investigation phase and the recommended boreholes are drilled in the subsequent detailed site investigation phase after geostatistical analysis. For the study site of this Example 1, a total of five boreholes (two actual boreholes and three recommended boreholes) obtained from the geostatistical analysis can be regarded as the ESIP (FIG. 6). A 3D view of the two actual boreholes and three recommended additional boreholes is shown in FIG. 7. The data for the three recommended boreholes is obtained virtually from the average of 100 simulated subsurfaces.

Referring back to the flowchart of FIG. 1, showing selected operations of an ESIP algorithm, the ESIP algorithm is implemented in an R program. Initial (actual) boreholes are drilled in proximity to pile foundations at operation 105. As described above, FIG. 2B shows the 3D view of the actual borehole layout showing the geological and ground properties of the Iowa bridge project site plan. Geological data and ground data from the initial (actual) boreholes and their location coordinates can be entered into the algorithm at operation 110 and operation 130, respectively. At operation 110, the size of the test site or random field is defined and discretized and the geomaterial type (geological property) from the actual borehole is assigned. Transition states are estimated with a spMC at operation 115. Multinomial categorical prediction is performed and multiple simulations are performed at operation 120.

Regarding the ground uncertainty (stage 102), the log-transformed geomaterial property (ground property) is assigned to the spatial locations or points of the random field and a model is selected for each of the multiple simulations at operation 130. A spatial correlation structure is estimated at operation 135. The geomaterial property (ground property) at the unsampled grids (locations) of the multiple simulations of the random field is predicted using conditional simulations at operation 140. In Example 1, the number of multiple simulations to be performed on the random field to propagate its uncertainties is specified to be 100 simulations (operation 145). In this example, the subsurface property is uniaxial compressive strength (UCS), qᵤ.

After application of the actual boreholes to the multiple simulated random fields, statistical summaries are obtained and uncertainties are quantified at operation 150. As described above, uncertainties in this example were quantified through the SD. FIG. 5A shows the actual (or initial) boreholes on a site. FIG. 5B shows is a heatmap showing the quantified uncertainty of how one borehole added to the actual boreholes at every possible locations on the site. The plus sign in FIG. 5A refers to the combination of boreholes and not summation. Here, the idea is to choose the location with the lowest uncertainty. To the inventors' knowledge, this method of recommending additional boreholes has not been utilized in conventional methods. As shown in FIGS. 5A and 5B, a subsequent borehole was recommended to be added to the initial boreholes (or CSIP boreholes) at the x-y location that decreases the SD the most within the random field. The recommended subsequent borehole was selected as the transverse-longitudinal location on the subsurface grid with the lowest SD. In this non-limiting example, the recommended location of the borehole in FIG. 5B is 70 ft (x-axis) and 20 ft (y-axis).

The initial borehole data was updated with the recommended borehole and was reapplied to the multiple simulated random fields. A subsequent borehole was again recommended to be added to the boreholes at the x-y location that decreases the SD the most. This process was repeated until the estimated number of initial (actual) and recommended boreholes is obtained. Referring to FIG. 6, the estimated number can be determined when, for example, there is no further reduction in the geomaterial uncertainties, measured in terms of SD (operation 155). In FIG. 6, columns B-1 to B-8 indicate the SD of each borehole (B) in relation to the geological property (clay, sand, till, and shale). The scree plot in FIG. 6 shows the estimated number of boreholes to be five total boreholes (two actual boreholes and three recommended boreholes). The five boreholes comes from the initial two (2) boreholes of CSIP, and boreholes 3-8 are the boreholes recommended that are virtually drilled to reduce uncertainty. ESIP is a combination of the initial 2 boreholes and the first 3 recommended boreholes (1-5).

The concept of multiphase SI was applied, where the initial boreholes are drilled at the pile foundation locations in the preliminary SI phase, and the recommended boreholes are drilled in the subsequent detailed SI phase after geostatistical analysis. Referring to FIG. 7, the test site now has five estimated boreholes (two actual boreholes and three recommended boreholes) with their respective locations (operation 160) to be used in Section 1.3 of Example 1 for pile design.

### 1.2.4. ESIP Validation

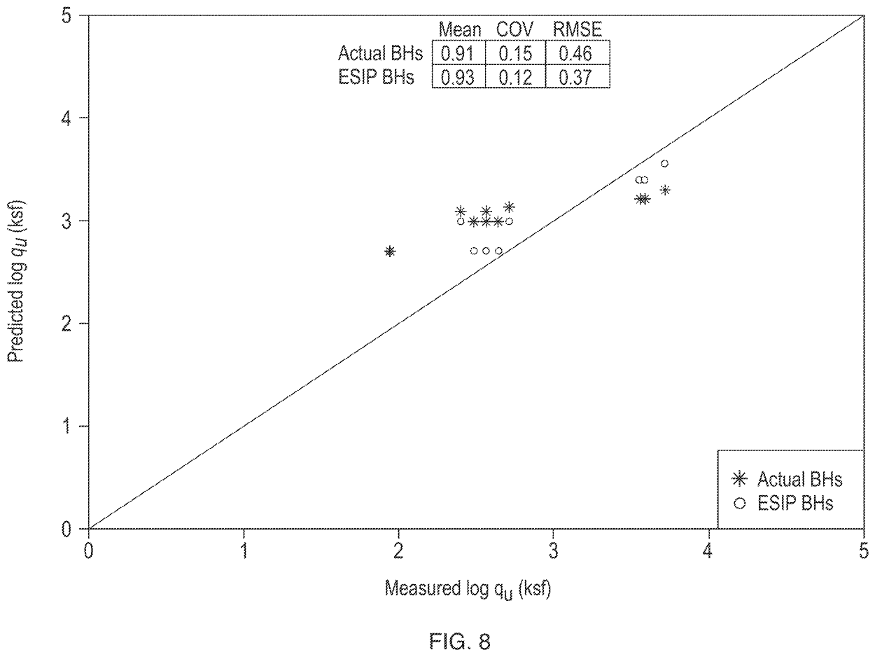

A validation process is conducted to compare the prediction accuracy of using the two actual boreholes closest to the borehole versus the five ESIP boreholes in simulating the ground property. The previously removed shallow boreholes (FIG. 3A) from the study site can be used as the validation dataset. The measured qᵤ values from these removed shallow boreholes are log transformed and are compared to the log qᵤ values predicted at the exact location of the removed borehole from the average of the 100 simulated subsurfaces. The simulated subsurfaces are obtained using the CSIP and the ESIP. A plot comparing the measured log qᵤ values from the removed boreholes (BHs) to the log qᵤ values predicted from using CSIP and ESIP as input data are shown in FIG. 8. FIG. 8 shows that the ESIP yields predictions that are closer to the equality line compared to the predictions generated from CSIP. In this example, the coefficient of variation (COV) measuring uncertainty and the root mean squared error (RMSE) measuring prediction error for the ESIP are 0.12 and 0.37, respectively. These values are significantly lower compared to the COV and RMSE for the CSIP of 0.15 and 0.46, respectively. These results, for example, establish the effectiveness of the recommended ESIP strategy in predicting ground property for the design of a pile foundation.

### 1.3. Pile Foundation Design and Site Investigation Plan

### 1.3.1. End-Bearing Resistance Prediction (Geotechnical-Structural Uncertainties)

To design a pile, engineers should be able to predict the pile and geomaterial resistance to the proposed load. A static analysis (SA) method is utilized to predict end-bearing resistances of H-piles driven into weathered shales. To reduce geotechnical-structural uncertainties, regional data and site-specific observations are gathered to develop a resistance prediction equation or static analysis method. The unit end-bearing or toe resistance \hat{q}ₚ of H-piles (in units of ksf) is predicted from the uniaxial compressive strength (qᵤ) of the shale in ksf using Equation 12:

$${\hat{q}}_{p} ( ksf ) = 45. 72 {q}_{u}^{0.35} \qquad ( Equation 12 )$$

wherein: \hat{q}ₚ is a unit end-bearing resistance (in units of ksf); and qᵤ is an uniaxial compressive strength (in units of ksf).

The prediction equation (Equation 12) for end-bearing resistance is restricted to qᵤ within a range of 3.24 ksf to 124 ksf. The predicted end-bearing resistance (in kips) is obtained by multiplying the unit end-bearing resistance \hat{q}p in ksf with the pile toe area in ft². The rest of the geotechnical structural uncertainties are accounted for by the probabilistic method used in calibrating the LRFD resistance factor for a target reliability index.

### 1.3.2. Current Pile Design Method Using CSIP

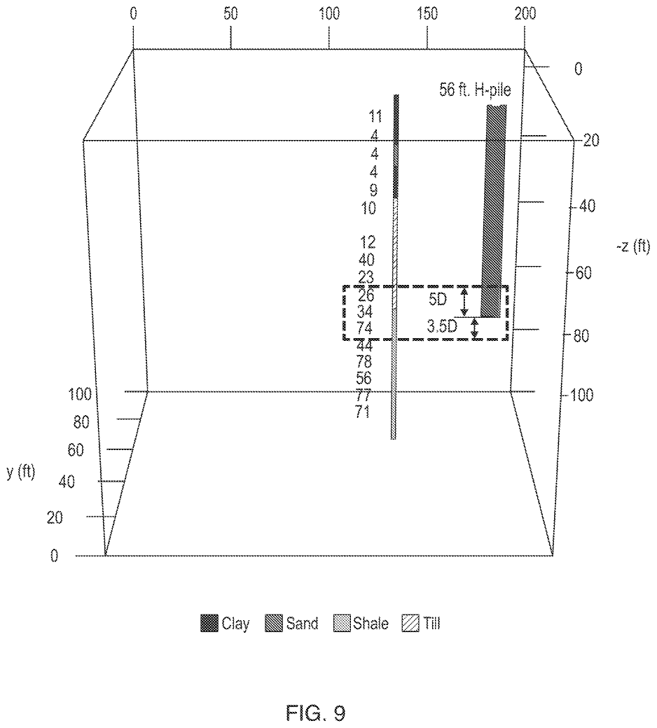

FIG. 9 shows a 56 ft long H-pile driven through overburden clay, sand, and till into the weathered shale bedrock of the bridge project site in Iowa, USA. As earlier described, the current practice in the design of the bridge pile foundation is to use the information of the borehole (from the actual boreholes or CSIP) in the nearest proximity to the pile. The closest borehole to the pile had a 100 ft depth and qᵤ values in ksf (FIG. 9) with an approximate distance of 46 ft between the borehole and the pile.

To estimate the end-bearing of the H-pile using a CSIP, the average of the qᵤ values in the dashed rectangular portion of FIG. 9 (for example, 26 ksf, 34 ksf, and 74 ksf) were substituted into Equation 12 and were multiplied by the pile toe area. The qᵤ values in the dashed rectangular portion were selected from the region of 5D above the pile toe and 3.5D below the pile toe to guard against punching failure in weathered shale due to lower stiffness for a pile with its width or diameter denoted as D. The average qᵤ value used in the end-bearing prediction does account for uncertainty. However, the CSIP used in pile design is limited for at least the reason that there is a noticeable distance of approximately 46 ft between the borehole and the test pile. Hence, an end-bearing prediction error may occur because of the variations in the qᵤ values measured at this region of the borehole and the qᵤ values that will be measured at the same region of the pile toe. In addition, the design engineer still needs to deal with the geomaterials uncertainties present on the project site because piles are constructed in groups.

1.3.3. Incorporating ESIP and Geostatistical Simulation into the Current Pile Design Method

This end-bearing resistance prediction can be improved using embodiments of the ESIP and geostatistical simulation described herein. The process adopts for its design the ground property prediction at the exact end-bearing location of the test pile. The geomaterial uncertainties associated with the geology and ground predictions for the site (and not just specific pile locations) are also reduced through the boreholes from the ESIP. Geostatistical methods are used to obtain additional quality data that reduce uncertainties and make a more accurate prediction of resistance. Geomaterial information from boreholes drilled in proximity to the foundation locations can be recommended. However, despite this proximity, there may still be spatial variation in the geomaterial properties between the pile and the borehole as described above earlier. Furthermore, the subsurface information from a borehole may not fully describe the subsurface condition of all piles in a group. Hence, uncertainties over the whole site, and not just specific borehole locations, can be considered in pile design.

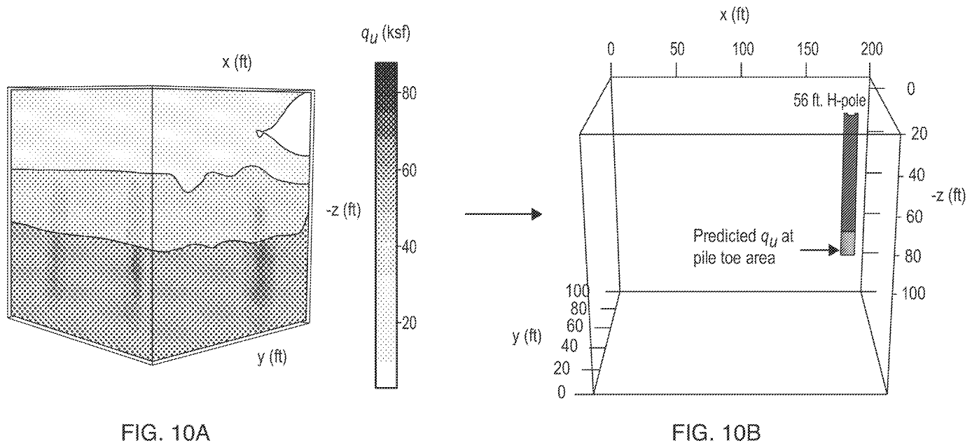

The predictions from the five ESIP boreholes (two actual boreholes and three recommended boreholes) in FIG. 7 are used as the new input data. These new input data are then used to re-simulate the geology and ground properties at the unsampled locations of the random field. The average of the qᵤ values in ksf from the 100 re-simulated subsurfaces for each of the grid locations on the random field is shown in FIG. 10A. An average random field can be obtained from the average of the qᵤ values from the multiple re-simulated random fields for each of the grid locations.

The average of the qᵤ values from the re-simulated random field are selected in the region of 5D above the pile toe and 3.5D below the pile toe. Referring to FIG. 10B, a pile is designed with Equation 12 using predicted qᵤ. Here, the average of the qᵤ values selected along the pile toe, as shown in FIG. 10B, is substituted into Equation 12 and multiplied by the pile toe area to estimate the end-bearing resistance. The improvement in the predicted log and back-transformed qᵤ values (as earlier described in the validation of ESIP) can also translate to improvement in the prediction of end-bearing resistance using Equation 12. This improvement is further described below in the study with the end-bearing bias distribution comparing the incorporation of site investigation plans (CSIP and ESIP) into the SA method of pile design.

### 1.4. Load and Resistance Factor Design (LRFD) Calibration

An objective of reliability-based LRFD calibration is to, for example, select load and resistance factors to be used in design such that the computed probability of failure is below the target probability of failure. By applying LRFD, the structure-limiting components are independently assessed, resulting in a more cost-effective design. The predicted end-bearing resistances for weathered shale bedrock in different foundation sites are used in calibrating the resistance factor (φ).

Table 1-1 shows a summary of the twenty-two (22) test pile foundation data obtained from the pile load test in the states of Kansas (KS), Iowa (IA), and Wyoming (WY) in the United States. The dynamic load test (DLT) is used as the referenced pile resistance for comparison due to the absence of the more expensive static load test (SLT) data. Past studies have shown that pile resistances determined from DLT agree relatively well with the measured resistance in IGMs from SLT. Table 1-1 also shows the numbers of initial/actual boreholes that make up the CSP and the numbers of ESIP boreholes for each test pile foundation. The ESIP boreholes are a combination of actual boreholes from CSP and recommended boreholes from the geostatistical analysis. The CSIP and ESIP resistances are predicted for each test pile. In Table 1-1, “1W” refers to H-pile; “resistance from dynamic load test” refers to actual measurement; “CSIP predicted resistance” refers to a conventional method's predicted resistance; and “ESIP predicted resistance” refers to the resistance predicted by embodiments described herein. The values for pile type are in depth (inches) and weight. For example, HP 12×74 is an H-pile with a depth of 12 inches and a weight of 74 pounds per linear foot.

TABLE 1-1
Summary of test pile data and end-bearing in weathered shale

| | | | | | | | | Resistance | | |
|---|---|---|---|---|---|---|---|---|---|---|
| | | | Initial | | | Depth | | from | CSIP | ESIP |
| | | | number of | Number of | | of pile | Toe | dynamic | predicted | predicted |
| | | Bridge | boreholes | boreholes | Pile | penetration | area | load test | resistance | resistance |
| State | County | project | (CSIP) | in ESIP | type | (ft) | (ft²) | (kips) | (kips) | (kips) |
| KS | Clay | US 24 | 1 | 5 | HP | 59 | 1.028 | 182.7 | 181.6 | 332.2 |
| | | over | | | 12 × 74 | | | | | |
| | | Huntress | | | | | | | | |
| | | Creek | | | | | | | | |
| | Clark | US- | 2 | 5 | HP | 94 | 1.383 | 82.8 | 111.8 | 107.8 |
| | | 183 | | | 14 × 73 | | | | | |
| | | over | | | | | | | | |
| | | Day | | | | | | | | |
| | | Creek | | | | | | | | |
| | Sedgwick | Ramp | 2 | 6 | HP | 80 | 0.694 | 94.1 | 66.0 | 75.9 |
| | | B (NB | | | 10 × 42 | | | | | |
| | | I-235 | | | | | | | | |
| | | to EB | | | | | | | | |
| | | US- | | | | | | | | |
| | | 54/400) | | | | | | | | |
| | | Ramp | 2 | 6 | HP | 73 | 1.000 | 96.3 | 79.4 | 82.1 |
| | | H (SB | | | 12 × 53 | | | | | |
| | | I-235 | | | HP | 68 | 1.028 | 162.5 | 143.4 | 155.8 |
| | | to EB | | | 12 × 74 | | | | | |
| | | US- | | | HP | 60 | 1.028 | 105.0 | 86.9 | 108.9 |
| | | 54/400) | | | 12 × 74 | | | | | |
| | | Ramp | 2 | 6 | HP | 87 | 1.000 | 132.8 | 103.8 | 95.8 |
| | | D SB | | | 12 × 53 | | | | | |
| | | I-235 | | | HP | 33 | 1.048 | 30.1 | 71.5 | 43.8 |
| | | to US- | | | 12 × 84 | | | | | |
| | | 54/400 | | | | | | | | |
| | | Maple | 2 | 6 | HP | 80 | 0.694 | 48.2 | 53.8 | 75.6 |
| | | Street | | | 10 × 42 | | | | | |
| | | over I- | | | | | | | | |
| | | 135 | | | | | | | | |
| | | I-235 | 8 | 12 | HP | 46 | 1.028 | 139.4 | 95.2 | 140.2 |
| | | Flood | | | 12 × 74 | | | | | |
| | | way | | | HP | 45 | 1.028 | 89.8 | 104.6 | 101.2 |
| | | crossing | | | 12 × 74 | | | | | |
| | | | | | HP | 53 | 1.028 | 102.8 | 99.9 | 99.8 |
| | | | | | 12 × 74 | | | | | |
| | | | | | HP | 61 | 1.028 | 40.8 | 63.9 | 41.5 |
| | | | | | 12 × 74 | | | | | |
| | | | 8 | 12 | HP | 59 | 1.005 | 50.9 | 69.1 | 55.2 |
| | | | | | 12 × 63 | | | | | |
| | | | | | HP | 58 | 1.005 | 133.7 | 90.0 | 103.8 |
| | | | | | 12 × 63 | | | | | |
| | | | | | HP | 47 | 1.005 | 61.3 | 75.3 | 69.6 |
| | | | | | 12 × 63 | | | | | |
| | | | | | HP | 50 | 1.028 | 48.2 | 71.0 | 48.9 |
| | | | | | 12 × 74 | | | | | |
| | | | | | HP | 35 | 1.028 | 147.8 | 146.9 | 158.1 |
| | | | | | 12 × 74 | | | | | |
| | Barton | K-4 | 2 | 5 | HP | 72 | 1.005 | 87.8 | 94.8 | 77.4 |
| | | over | | | 12 × 63 | | | | | |
| | | Cow | | | HP | 79 | 0.694 | 66.5 | 53.7 | 57.9 |
| | | Creek | | | 10 × 42 | | | | | |
| | | Drainage | | | | | | | | |
| IA | Adair | Adair | 2 | 5 | HP | 56 | 0.709 | 38.0 | 60.6 | 47.8 |
| | | Highway | | | 10 × 57 | | | | | |
| | | 92 | | | | | | | | |
| WY | Natrona | Casper | 2 | 6 | HP | 21 | 1.411 | 217.0 | 134.0 | 142.3 |
| | | West | | | 14 × 89 | | | | | |
| | | Belt | | | | | | | | |
| | | loop | | | | | | | | |

To estimate the performance of ESIP against CSIP, a resistance factor was calculated. To calculate the resistance factor (φ), the resistance bias for each test pile foundation can be calculated using Equation 13A:

$${bias}_{( i )} = \frac{{y}_{( i )}}{{\hat{y}}_{( i )}} \qquad ( Equation 13 A )$$

where i=1, . . . , 22 indexes the test pile foundation; y₍ᵢ₎ is a resistance determined from the load test (DLT) on pile i; and ŷ₍ᵢ₎ is a predicted resistance from using CSIP and ESIP incorporated into the end-bearing resistance prediction equation for pile i (the SA pile design method for pile i).

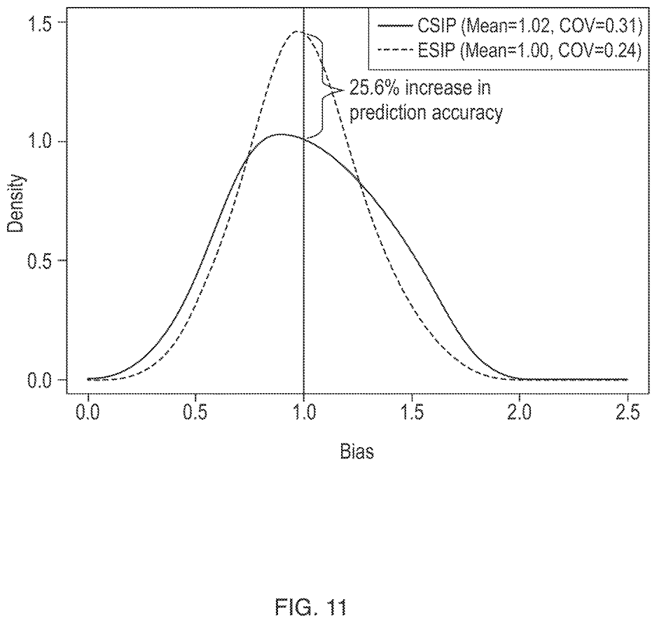

FIG. 11 The mean and coefficient of variation (COV) of the resistance bias for the twenty-two test pile data.

In this example, the bias distribution indicates that the ESIP, with a COV of about 0.24, performs significantly better in predicting the end-bearing resistance of the pile than CSIP with a COV of 0.31. The incorporation of ESIP and simulation decreases the prediction error associated with CSIP by about 25.6%. Put another way, the incorporation of ESIP and simulation increases the prediction accuracy associated with CSIP by about 25.6%.

Monte Carlo (MC) simulation for a lognormal distribution is used to calibrate the LRFD resistance factors. The procedure for MC involves generating random resistance bias using statistical summaries (e.g., mean, standard deviation) to specify the lognormal distribution. The number of simulations (N) is dependent on the coveted accuracy level, COV of resistance bias, and target reliability index (β_{T}), or combinations thereof. In some embodiments, the value N is set to 1,000,000. The limit state function with the generated random resistance bias is evaluated and a trial resistance factor φ is assumed. The number of failures (N_{f}) where the load is equal to or greater than the resistance is recorded. The probability of failure (P_{f}) and the reliability index (β) are estimated as follows:

$${P}_{f} = \frac{{N}_{f}}{N} \qquad ( Equation 13 B )$$

$$\begin{matrix}β = {Φ}^{- 1} ( 1 - {P}_{f} ) & ( Equation 13 C )\end{matrix}$$

wherein: Φ⁻¹ is the inverse cumulative distribution function for the standard normal distribution.

If the estimated β from Equation 13C is different from the target β_{T}, a new trial resistance factor φ is assumed and the process is repeated until the target β_{T} is achieved. In some examples, the target β_{T} values are set as 2.33 and 3.00 for redundant and nonredundant pile groups, respectively. The calibrated resistance factors (φ) and efficiency factors (φ/λ_{R}) for the target β_{T} values are summarized in Table 1-2 for the CSIP and ESIP.

TABLE 1-2
LRFD calibration for end-bearing H-
piles driven into weathered shale

| Site | | | | | | | |
|---|---|---|---|---|---|---|---|
| investigation | Sample | Mean bias | | β_{T} = 2.33 | | β_{T} = 3.00 | |
| plan | size | (λ_{R}) | COV_{R} | φ | φ/λ_{R} | φ | φ/λ_{R} |
| CSIP | 22 | 1.02 | 0.31 | 0.59 | 0.58 | 0.47 | 0.47 |
| ESIP | 22 | 1.00 | 0.24 | 0.71 | 0.71 | 0.60 | 0.60 |

In this example, and as shown in Table 1-2, the resistance factor (φ) and the efficiency (φ/λ_{R}) of the ESIP are approximately 20% higher than that of the CSIP at a target reliability index of 2.33 indicating a significant improvement.

Example 1 demonstrates, for example, the incorporation of ESIP and geostatistical simulation into the probabilistic design of bridge pile foundations. ESIP is a process of adding borehole locations to the actual boreholes or CSIP to reduce geomaterial uncertainties. Overall, the data shows that embodiments described herein (ESIP) can be used to recommend borehole location to the initial boreholes (or CSIP boreholes) to reduce geomaterial uncertainties (e.g., geological and ground uncertainties). Reducing the uncertainties can improve the accuracy of the end-bearing prediction obtained from the prediction equation (e.g., the SA method) for piles driven into geomaterial (e.g., weathered shale). Further, the validity of ESIP is determined by comparing its prediction accuracy to that of the actual borehole data (CSIP). ESIP gave a significantly more accurate geomaterial prediction compared to CSIP. Hence, the use of the recommended boreholes as enabled by embodiments described herein can improve pile design. In addition, the resistance bias distribution shows that ESIP can reduce the prediction error of end-bearing by 25.6% when compared to CSIP. ESIP can yield a lower COV of 0.24 compared to the COV of 0.31 for CSIP. This comparison indicates that the incorporation of ESIP into pile design performed better in the prediction of end-bearing resistance than CSIP. Moreover, ESIP can lead to a 20% increase in the end-bearing resistance factor (φ) and efficiency (φ/λ_{R}) from that based on CSIP at a target reliability index of 2.33.

### Example 2: Example Site Investigation for Bridge Foundation Design

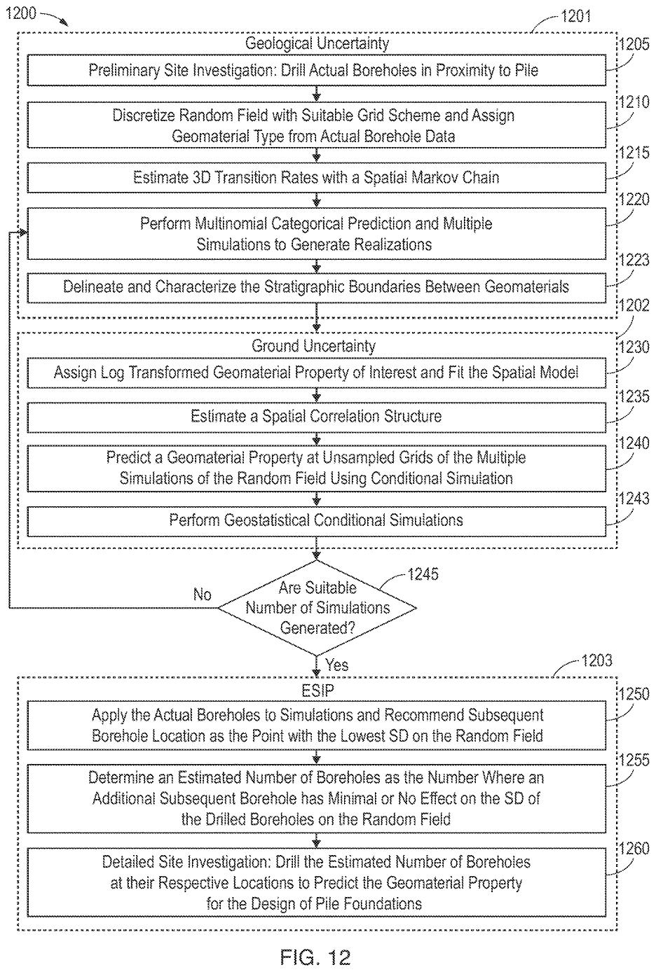

Site investigation data used for Example 2 are from a bridge project in Iowa, USA, which includes four boreholes, each within the proximity of the pile foundation location. Subsequent numbers of recommended boreholes and their associated locations can be determined to adequately minimize the combined uncertainties. The effectiveness of this combined analysis of geological and ground (property) uncertainties for determining an ESIP can be validated and compared to an analysis done solely on ground uncertainty. Various embodiments described with respect to FIG. 1 can be utilized or combined with embodiments of FIG. 12 discussed below.

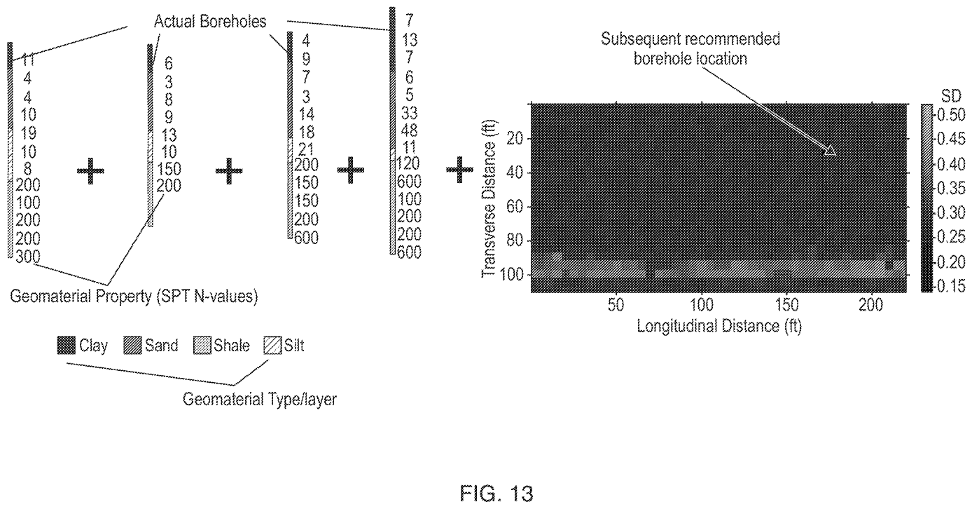

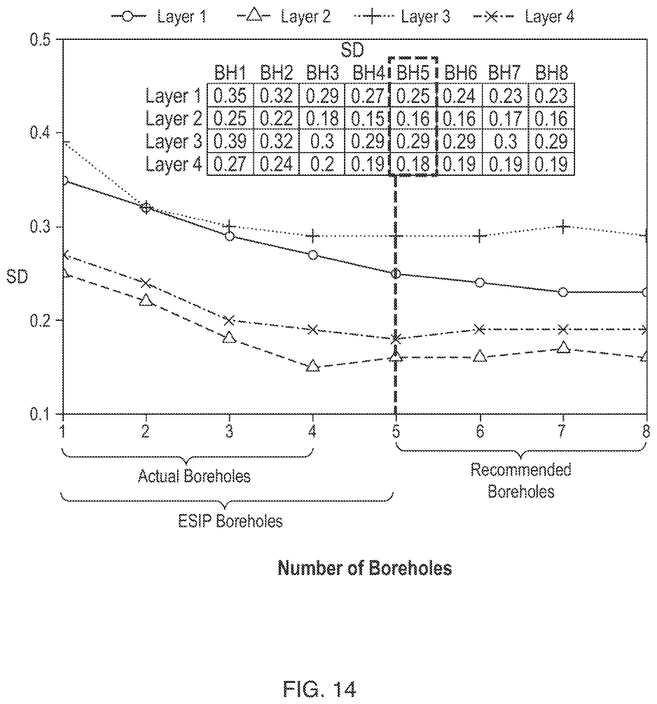

The algorithm to obtain an ESIP was implemented in an R program. Inputs utilized for the algorithm can include the 3D random field measurement, transverse-longitudinal coordinates of the boreholes, the sampled geological property, the ground property of interest at each subsurface depth examined, or combinations thereof. An example method 1200 for determining the ESIP for a bridge design is summarized in FIG. 12. The method 1200 is an algorithm to determine an ESIP for a pile design through a combined analysis of geological uncertainty (stage 1201) and ground uncertainty (stage 1202). ESIP (stage 1203)—dashed box around operations 1250, 1255, and 1260), —in the context of FIG. 12, is the process of recommending additional boreholes with the CSIP or initial boreholes on the site to reduce the unknowns and uncertainties. The procedure can generally include one or more of the following operations:
(0) A preliminary (initial) site investigation is performed where actual (initial) boreholes are drilled in proximity to pile foundations (operation 1205). Operation 1205 can be similar to operation 105.
(1) Discretizing a random field (e.g., a design relevant bridge domain) into several 3D grids with a suitable grid scheme (operation 1210). The R package, R:expand grid, can be utilized. Suitable grid schemes include those that are computationally efficient.
(2) Setting out or assigning a known geological property(ies) of the actual boreholes to the corresponding grid location(s) of the 3D grids (operation 1210). This information can be conditional for the prediction of the geological property and for quantifying the geological uncertainty. Operation 1210 can be similar to operation 110. The known geological property(ies) of the actual boreholes can include actual borehole data gathered from a site, a CSIP, or combinations thereof, among others.
(3) Estimating a 3D transition rate(s) (and/or probability(ies)) of the known geological property(ies) using a Spatial Markov Chain, such as a Spatial Markov Chain described in Example 3 (operation 1215). Transition rates matrices along axial directions and proportions of categories can be computed. The R package, R:multi_tpfit, can be utilized (Multidimensional Model Parameters Estimation). Operation 1215 can be similar to operation 115. The 3D transition rate provides a value that can be converted to a transition probability by utilizing, for example, Equation 2.
(4) Based on the three-dimensional transition rate, predicting an unknown geological property(ies) at an unsampled location(s) of the discretized random field by performing a multinomial categorical prediction (MCP), and simulating geological uncertainty multiple times to generate a plurality of realizations based on the MCP prediction (operation 1220). The realizations are images of the random field that contain the predictions. The simulating geological uncertainty to generate the plurality of realizations can include performing Monte Carlo simulations on the unknown geological property(ies) to generate a plurality of realizations. The R package, R:sim_mcs, can be utilized (Multinomial Categorical Simulation, MCS, in spMC). Operation 1220 can be similar to operation 120.
(5) Characterizing (e.g., describing and/or delineating) a stratigraphic boundary(ies) of each different realization of the plurality of realizations generated in operation (4) to produce stratified realizations (operation 1223). In use, operation (5) can be performed using information entropy (Equation 7). High information entropy values at certain locations indicate higher uncertainty, which are potential areas where different geomaterial layers might interface. The characterization result can be more accurate and comprehensive, identifying nonlinear boundaries between different geomaterials more effectively than conventional linear methods. At this stage, the stratigraphic boundary(ies) are characterized and the geological uncertainty data utilized to predict the geological property (type) is completed. The geological uncertainty can be transferred to the ground properties through the characterization of the geological or stratigraphic boundary(ies) before the ground data integration into the random field. The stratified realizations include stratigraphic boundaries. Stratified realizations generally refer to the images of the various possible models or scenarios generated through geostatistical simulations, considering the spatial variability and uncertainty in geological strata. These stratified realizations can aid in understanding the range of possible subsurface conditions. Stratigraphic boundaries generally refer to the physical demarcations between different geological layers or strata. These stratigraphic boundaries can be identified based on changes in rock types, soil composition, combinations thereof, or other suitable geological property.
(6) Log transforming the known geomaterial property(ies) (ground property(ies)) and assigning the log-transformed ground property(ies) to the stratigraphic boundaries to form a spatial model (operation 1230). The spatial model is then fit with a spatial correlation structure of the log-transformed known ground property(ies) (operation 1235). The spatial correlation structure can be estimated based on the actual borehole data. The R package, R:lme[nlme], can be utilized (non-linear mixed-effects models). Additionally, the R package, R:gls[nlme,likfit], can be utilized. Operation 1230 can be similar to operation 130. Operation 1235 can be similar to operation 135. As an example of operation (6), the geological uncertainty data is transferred to the ground property(ies) in order to determine (e.g., quantify) both the geological uncertainty and the ground uncertainty. For example, the uncertainty associated with clay (developed in stage 1201) can be combined with the ground properties of the clay from the actual boreholes.
(7) Predicting, using universal kriging (UK) (operation 1240), and conditionally simulating the unknown ground property values (operation 1243) at unsampled location(s) of the discretized and geological property stratified bridge domain. After predicting the ground properties containing the geological uncertainty, the combination of geological and ground uncertainties is simulated. The R package, R:krige[gstat], can be utilized. Operations 1240 and 1243 can be similar to operation 140. As an example of operation (7), an unknown ground property(ies) containing the unknown geological property(ies) at unsampled location(s) of the stratified realizations based on the fitted spatial model can be predicted (operation 1240), and geostatistical conditional simulations can be performed on the unknown ground property(ies) containing the unknown geological property in the random field to quantify ground uncertainty and geological uncertainty resulting from the unknown ground property and unknown geological property, respectively (operation 1243).
(8) Repeating operations (5)-(7) for the stratigraphic boundaries of each different realization generated in operation (4). For example, this is a repeat of operations 1223-1243 shown in FIG. 12. The operations can be repeated until, for example, an additional simulation produces less than +1% change in the ground uncertainty value. The answer at operation 1245 can be “yes” if the additional simulation produces less than +1% change in the ground uncertainty value and no if the additional simulation produces more than ±1% change in the ground uncertainty value. Operation 1245 can be similar to operation 145. As described herein, the ground uncertainty incorporates the geological uncertainty. To the inventors' knowledge, this incorporation of geological uncertainty into ground uncertainty has not been utilized in conventional methods.
(9) The sample means and SDs for each geological property or layer depth are summarized across all conditional simulations and sampling location(s) of the four actual boreholes shown in the left portion of FIG. 13 (operation 1250). The SD is then used in assessing the combined geological and ground uncertainties for a given site investigation plan. The plus signs in FIG. 13 refers to the combination of boreholes and not summation.
(10) Recommending a subsequent new borehole by adding boreholes to the actual boreholes at every possible location on the random field (or predicted subsurface) as shown in the right portion of FIG. 13 (operation 1250). As shown in FIG. 13, the recommended subsequent borehole can be selected as the transverse-longitudinal location on the random field (or predicted subsurface) grid with the lowest SD. Operation 1250 drills (virtually) one or more recommended boreholes with the actual boreholes to get a SD of how the one or more recommended borehole will perform. The lowest number on the heat map of FIG. 13 (right portion) is targeted. For example, a recommended borehole is virtually drilled to provide 5 total boreholes (4 actual and 1 recommended). Operation 1250 can be similar to operation 150.
(11) Updating (for example, adjusting, changing) the actual borehole data with data from the recommended boreholes, and repeating operations (9) and (10) until the SD is reduced to a point where, for example, further reduction is no longer cost-effective (operation 1255). Here, and continuing with the example in operation (10), one or more recommended boreholes can be added to the virtual site until a suitable SD (e.g., lowest number in the heat map) is reached. The simulated number with the suitable SD is the estimated number of boreholes determined. The estimated number of boreholes is the actual boreholes plus the recommended boreholes based on the SD. The selection of the estimated number of boreholes can be visualized with a scree plot where SD (uncertainty) was plotted against the number of boreholes (cost) as shown in FIG. 14. In FIG. 14, columns BH1 to BH8 indicate the SD of each borehole (BH) in relation to the geological property (clay, sand, till, and shale). Operation 1255 can be similar to operation 155.

As an example of operations (9)-(11), actual boreholes (such as location and/or property data) can be applied/assigned to the conditional simulations produced in operation (7). A plurality of virtual boreholes can then be added/assigned to locations in the conditional simulations produced in operation (7) to provide a plurality of standard deviation values associated with each virtual borehole of the plurality of virtual boreholes. This can be repeated until a suitable SD is reached. At this stage, a recommended borehole location can then be selected based on the virtual borehole with the lowest standard deviation value. Then, an estimated number of boreholes can be determined as the number where an additional virtual borehole has a minimal effect on the standard deviation.

At this stage, a detailed site investigation plan is produced. The detailed site investigation can be delivered to an engineer. The engineer can then drill the recommended boreholes in accordance with the site investigation plan (operation 1260). If desired, new data from the recommended boreholes drilled can then be compared to the ones drilled virtually. Operation 1260 can be similar to operation 160.

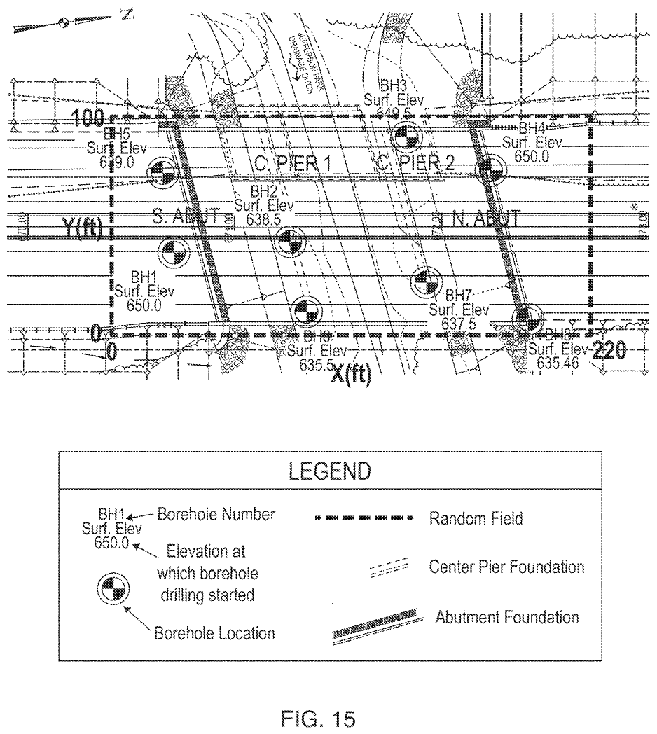

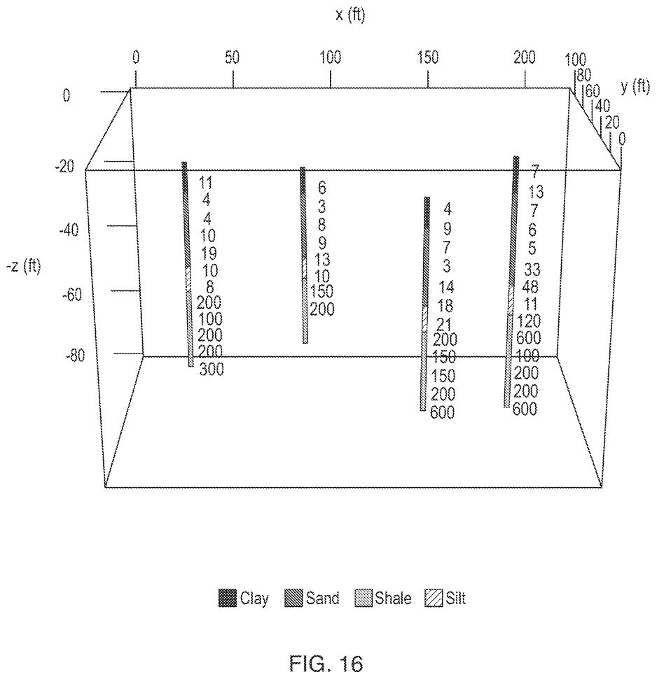

The data for this study is from the standard penetration test conducted on a project site by the Iowa Department of Transportation (IADOT) to replace an existing bridge and culverts over a drainage ditch in Iowa. Eight boreholes (BH1 to BH8) are drilled on the project site as shown in FIG. 15. In FIG. 15, “C. PIER 1” refers to center pier 1, “C. PIER 2” refers to center pier 2, “S. ABUT” refers to south abutment, and “N. ABUT” refers to north abutment. These are the four bridge foundations. Standard penetration test (SPT) is a common in-situ test used by engineers to obtain geomaterial samples from the boreholes and its N-value is an indirect measurement of geomaterial resistance. The N-value is the number of hammer blows per ft by which a 140-lb hammer with a 30-inch drop height can drive a split spoon sampler 1 ft into geomaterial. For the shale (IGM) layer, a full 1 ft penetration is not achieved by the sampler. Hence, measured blows are linearly for comparable and consistent analysis. A total of 46 SPT N-values from the four boreholes in proximity to the four bridge foundation locations are used as shown in FIG. 16. The foundation locations on the study site are namely N. ABUT.), C. PIER 1, C. PIER 2, and S. ABUT. The four remaining boreholes expunged from the ESIP analysis are used as validating data. Also, their relative locations are compared with the subsequently recommended boreholes from the ESIP analysis. The subsurface is characterized according to the borehole data into four geomaterial layers with layer 1 including dark brown-gray stiff clay (denoted as Clay), layer 2 including brown-gray clayey/fine sand to coarse sand, (denoted as Sand), layer 3 including the gray firm to stiff silt with brown firm sand clay with brown-gray firm clay and gravel (denoted as Silt), and layer 4 as the IGM layer including gray slightly to moderately weathered shale (Shale).

Embodiments described herein can utilize the borehole data from the preliminary site investigation and analyze it for spatial locations that will reduce uncertainty for all layers or a target layer. The actual borehole data from the preliminary site investigation can be recommended to be taken in proximity to the foundation to reduce the uncertainties that may be propagated to the design. However, it should be noted that the preliminary site investigation of locating boreholes in the proximity of the foundation may not be sufficient for a design as there are still unknowns (uncertainties) within the site. Also, piles are designed and constructed in groups, and borehole information can at best be limited to the design of a pile closest to the borehole.

The 3D random field for the study site has the following dimensions of +220 ft by +100 ft by −80 ft for the x, y, and z axes, respectively. The negative sign in the z-axis indicates depth below the ground surface. The SPT N-values are log transformed.

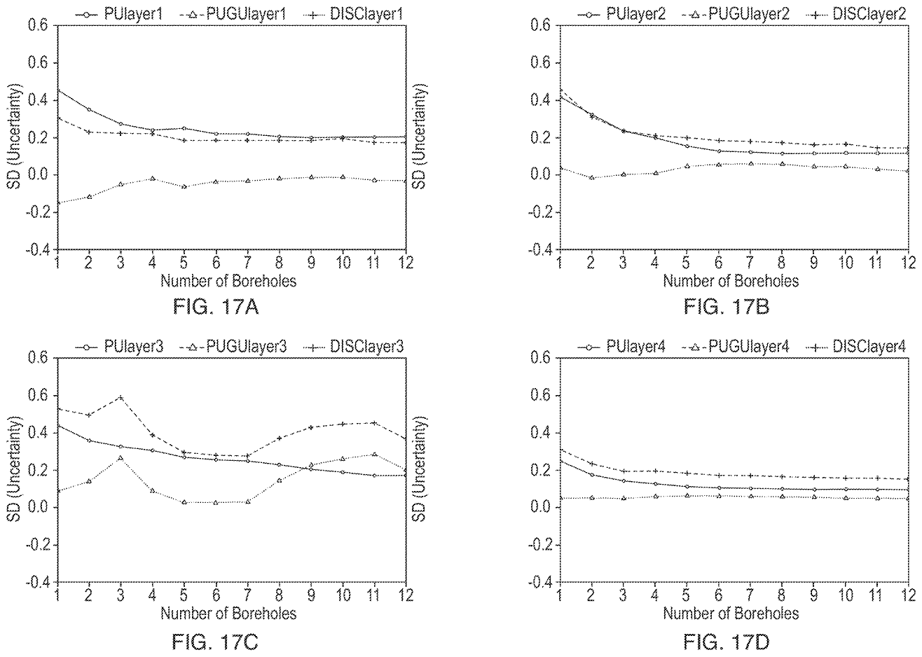

The model considering both geological and ground uncertainties in determining an ESIP was compared to a conventional model where only ground uncertainty is considered. Twelve boreholes comprised of eight actual preliminary boreholes (FIG. 15) and four recommended boreholes initially determined for uncertainty reduction for a bridge project in Iowa were analyzed for their uncertainties using the model in the present investigation. The uncertainties in terms of SDs present in each layer are compared as shown in FIGS. 17A-17D for the conditional simulation. The term ‘discrepancies’ denoted as DISC in FIGS. 17A-17D is a measure of the difference in the quantified uncertainties between the present investigation considering both geological and ground uncertainties denoted as PUGU and one considering only ground uncertainty denoted as PU.

The uncertainty discrepancies in both models (PUGU model and PU model) for layers 1, 2, and 4 as described above are within ±0.1 with an increase in the number of boreholes. However, for layer 3, the uncertainty discrepancy is as high as 0.3 at three boreholes. These high discrepancies in the quantified uncertainties from both models for layer 3, which is the transitional layer before the Shale layer (layer 4), may be due to the thinness of the layer as revealed by the boreholes in FIG. 16. Interestingly, for layer 3, the uncertainty discrepancy is as low as 0.02 at six boreholes which is the same as the estimated number of boreholes recommended for the study considering ground uncertainty alone.

Validation of a model can provide insights into the practical viability of resulting predictions. The ground property(ies) from sampled borehole data (yᵢⱼ) can be used to assess the model prediction accuracy because, for example, these observations give the measured value of the ground property response. Here, j=1, 2, . . . , b indexes b boreholes and i=1, . . . n_{b} indexes n_{b} observations within a borehole. Leave one-out cross validation is used because it will be performed on the entire data resulting in the estimation of the same test error.

First, the data was split into two parts where one part is the training data which includes all the sampled boreholes, except for the one borehole used in the second part for testing data. The training data is used to predict the geotechnical property for the n_{b} observations within the testing borehole (ŷ₍ᵢⱼ₎) and compared to the sampled or measured geotechnical property for the testing borehole (yᵢⱼ). The process is then repeated for each of the b available boreholes. The combined evaluation of these predictions involving the testing boreholes is obtained by the root mean squared error (RMSE) in Equation 14:

$$RMSE = \frac{1}{b} {{\sum }_{j = 1}^{b} [ \frac{1}{{n}_{b}} {\sum }_{i = 1}^{{n}_{b}} {( {\hat{y}}_{( ij )} - {y}_{( ij )} )}^{2} ]}^{\frac{1}{2}} \qquad ( Equation 14 )$$

The predicted ground property on the random field (predicted subsurface) can be used because, for example, it is more suitable to assess model accuracy through it rather than a smoothened mean estimate from multiple simulations. Bias is also calculated for the ground property prediction in each observation within a borehole. The bias for each test is defined by Equation 15:

$${Bias}_{( ij )} = \frac{{y}_{( ij )}}{{\hat{y}}_{( ij )}} \qquad ( Equation 15 )$$

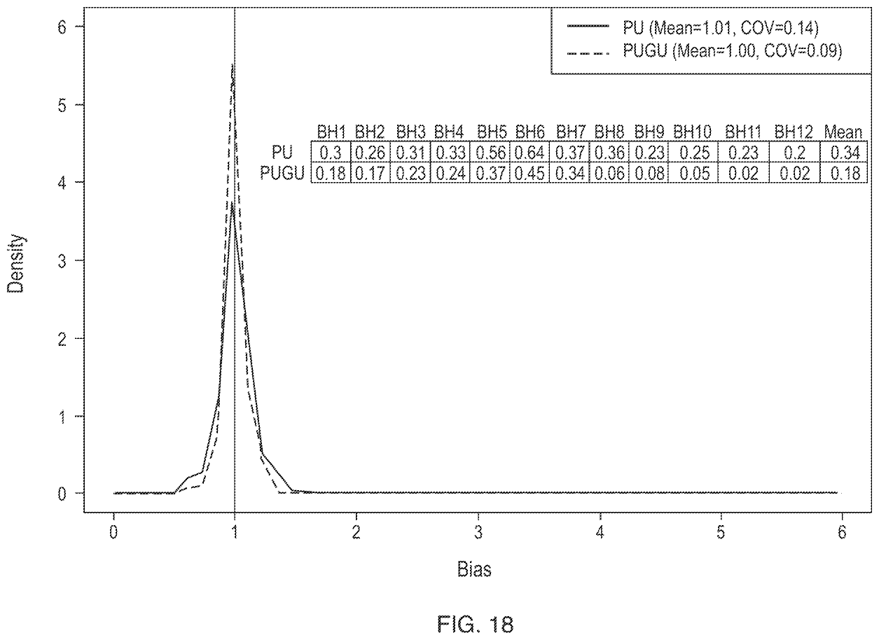

The model accuracy plot with the bias distribution of the PUGU and PU models and the corresponding RMSE is shown in FIG. 18. In FIG. 18, BH refers to borehole. The bias distribution plot shows that the PUGU model had a mean bias value equal to 1. The coefficient of variation (COV) of the bias in the PUGU model is 0.09 compared to 0.14 in the PU model. The trend is also consistent with the RMSE obtained from the cross validation where the PUGU model has a lower mean prediction error of 0.18 compared to the 0.34 obtained from the PU model. In other words, consideration of geological uncertainty in the prediction of ground property can decrease the prediction error on an average from 34% to 18%. In addition, the high RMSE value recorded when borehole 6 is used as the testing data. Recall, that six boreholes have been recommended as the estimated number of boreholes.

### 2.1. Geological Property (Geomaterial Type) Prediction

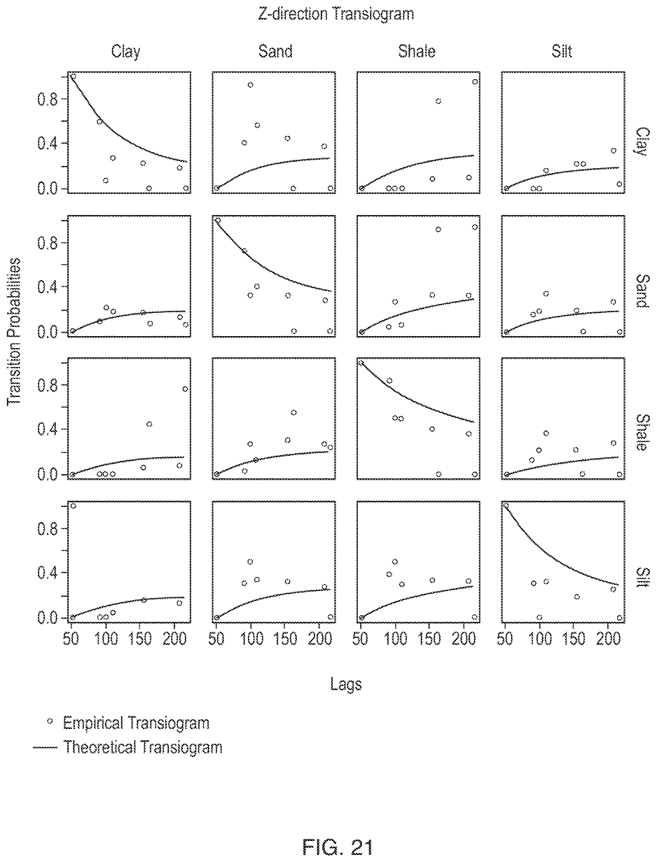

The estimate of the transition rate matrices in Equation 3 using the borehole data is presented in Table 2-1. From these transition rates, the transition probabilities are estimated using Equation 2. A transiogram model is fit to the estimated transition probabilities in the z-direction (depth) as shown in FIG. 19. The transiogram is analogous to the variogram used in the prediction of unknown ground property at unsampled spatial locations. The transiogram represents the conditional probabilities of an unknown geological property along a certain directional axis and Euclidean distance (lag) from an sampled geomaterial at any spatial point. For instance, for the transiogram in the z-direction at lag 50 (FIG. 19), there is a 75% probability that Shale will transition to Shale, 10% probability that Shale will transition to Sand, 8% probability that Shale will transition to Clay and 7% probability that Shale will transition to Silt. From Table 2-1, the transition rates in the y-direction and z-direction are higher than in the x-direction which may be due to their lengths and the layout of the geomaterials. The negative values in the diagonal of the transition rate matrices in Table 2-1 are consistent with the inverse relationship of the graph in the diagonal of the transiogram in FIG. 19.

TABLE 2-1
3D estimated transition rate matrices obtained
using the maximum entropy method

| | | | | |
|---|---|---|---|---|
| Geomaterial class | Clay | Sand | Silt | Shale |

x-direction estimated transition rate matrix

| | | | | |
|---|---|---|---|---|
| Clay | −0.012 | 0.005 | 0.003 | 0.004 |
| Sand | 0.003 | −0.009 | 0.003 | 0.003 |
| Silt | 0.003 | 0.004 | −0.010 | 0.003 |
| Shale | 0.002 | 0.003 | 0.002 | −0.007 |

y-direction estimated transition rate matrix

| | | | | |
|---|---|---|---|---|
| Clay | −0.055 | 0.020 | 0.013 | 0.022 |
| Sand | 0.016 | −0.055 | 0.015 | 0.024 |
| Silt | 0.014 | 0.020 | −0.055 | 0.021 |
| Shale | 0.017 | 0.023 | 0.015 | −0.055 |

z-direction estimated transition rate matrix

| | | | | |
|---|---|---|---|---|
| Clay | −0.039 | 0.013 | 0.013 | 0.013 |
| Sand | 0.012 | −0.054 | 0.021 | 0.021 |
| Silt | 0.026 | 0.044 | −0.114 | 0.044 |
| Shale | 0.011 | 0.019 | 0.019 | −0.049 |

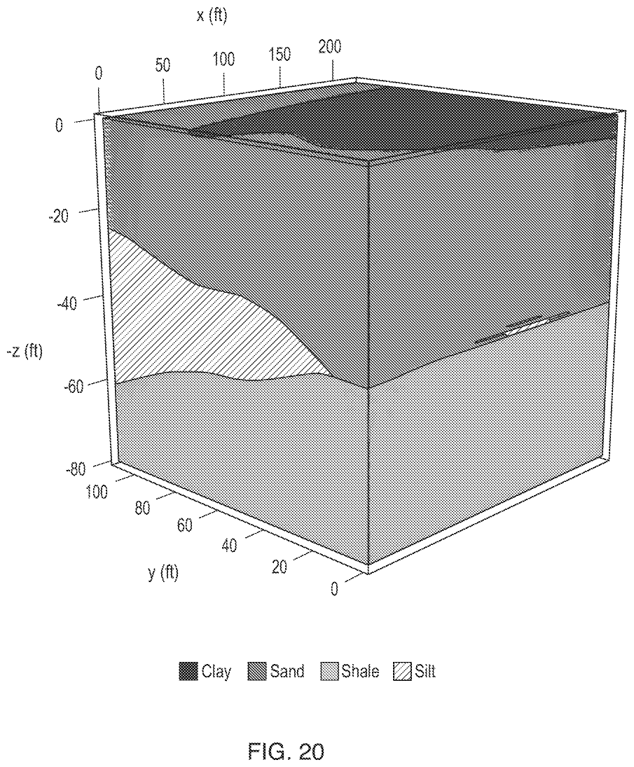

The simulated subsurface averaged over multiple simulations for the geological property is shown in FIG. 20. A total of 100 simulations are deemed adequate as additional simulations resulted in less than +100 change in the information entropy. This simulated geological property in the random field contains the geological uncertainties to be considered along with ground uncertainties. The incorporation of geological uncertainty will enhance the separation of the four geological properties on the simulated subsurface in FIG. 20 into layers through highly nonlinear spatial boundaries unlike previous methods of treating the subsurface as a single layer or multiple layers determined through the linear interpolation of the historical geological data. These spatially determined layers are thereafter analyzed collectively with different averages of the ground property by layer to accurately predict the subsurface ground property.

### 2.2. Ground Property (Geomaterial Property) Prediction

The SPT N-values measured from the boreholes are log transformed and the average for each of the four spatially determined layers is estimated. Due to, for example, the sparse borehole data and the thinness of some layers, separate spatial correlation structures were not defined for the different spatially determined layers. The exponential correlation structure is used because it incorporates spatial correlation. Assumptions of anisotropy and isotropy are checked by fitting these models for log SPT N-values with the Exponential spatial structure in the x-z and y-z directions and by comparing the information criteria presented in Table 2-2. In Table 2-2, smaller information criteria is better. In Table 2-2, “GLM” refers to generalized linear model, “n2llik” refers to negative 2 times the log-likelihood, “AIC” refers to Akaike information criteria, “AICc” refers to Corrected Akaike information criteria, and “BIC” refers to Bayesian information criteria.

TABLE 2-2
Information criteria of the GLM with exponential spatial
correlation for the x-z and y-z coordinate systems

| | x-z | | | | y-z | | | |
|---|---|---|---|---|---|---|---|---|
| GLM | n2llik | AIC | AICc | BIC | n2llik | AIC | AICc | BIC |
| Isotropic | 97.08 | 109.08 | 111.24 | 119.51 | 95.43 | 107.43 | 109.58 | 117.85 |
| Anisotropic | 96.97 | 112.97 | 116.87 | 126.87 | 92.92 | 108.92 | 112.81 | 122.82 |

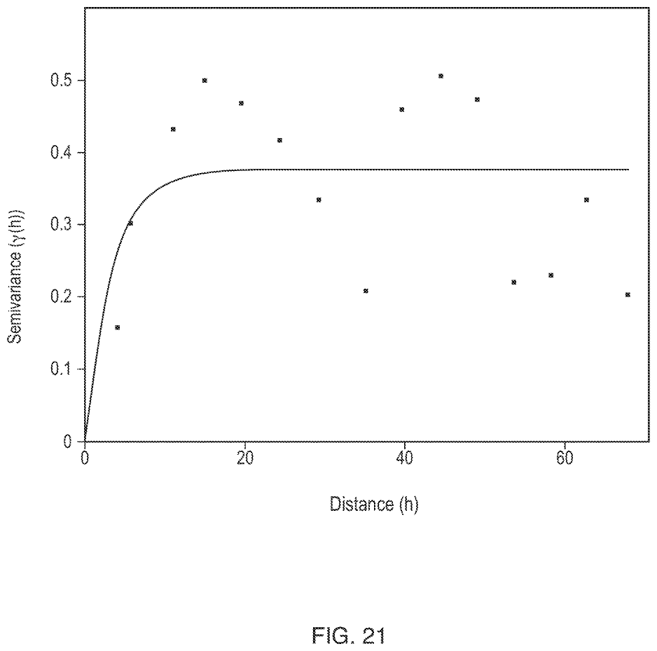

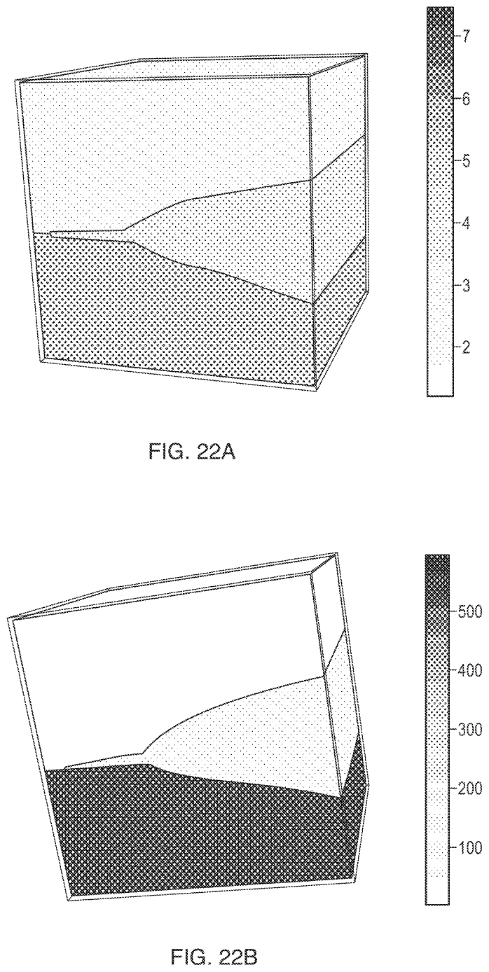

The data shows that the isotropic model can be preferable for both combinations based upon smaller AIC and BIC. This result indicated that the covariance structure does not change with direction. A variogram of log SPT N-values using the fit of an exponential model and no nugget is shown in FIG. 21 (plot of semivariance (γ(h)) versus distance). Prediction of log SPT N-values for the subsurface is done using universal kriging such that the different layers are analyzed with the respective average of log SPT N-values. Log SPT N-values are conditionally simulated for each of the 100 four-layered subsurfaces. The log SPT N-values simulated subsurface are back-transformed to obtain SPT N-values in blows/ft on the original scale. The simulated subsurfaces are averaged for the log-transformed and back-transformed predicted SPT N-values as shown in FIGS. 22A and 22B, respectively. The determination of the recommended borehole locations and the borehole numbers for the ESIP is based on the 100 conditionally simulated subsurfaces containing the log predicted SPT N-values.

### 2.3. ESIP

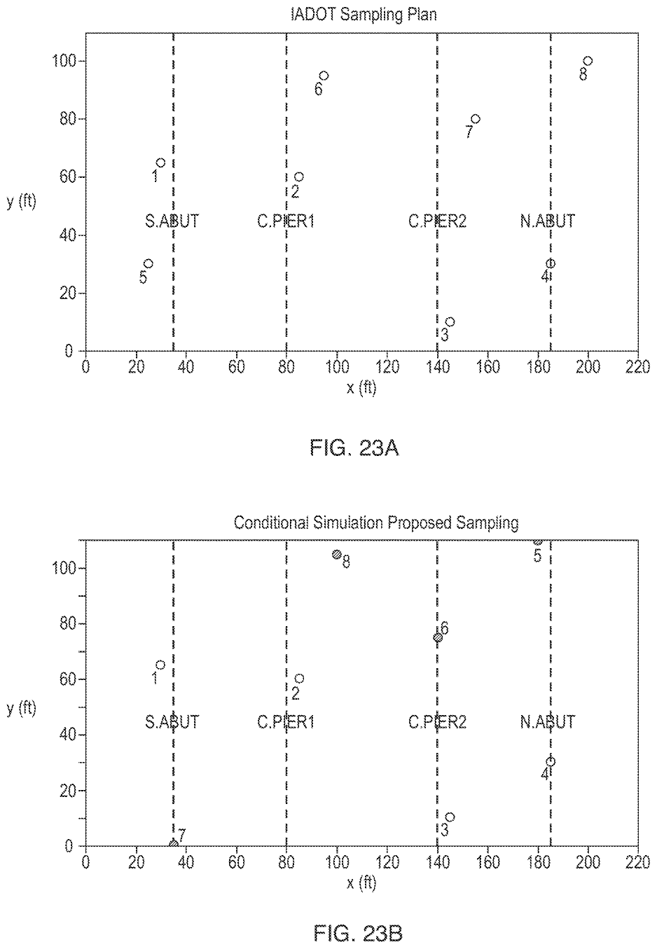

At this point, a real site plan (from IADOT) is compared to a partially virtual site plan (an example of the present disclosure). FIGS. 23A and 23B show a comparison of site investigation plans with relative borehole drilling locations as obtained from IADOT sampling data (FIG. 23A) and conditional simulations (FIG. 23B). The borehole locations from the IADOT sampling plan are selected based on current site investigation practice. The boreholes from the conditional simulations are drilled at locations where both geological and ground uncertainties are minimized for the shale or IGM layer over the 100 conditional simulations of predicted log SPT N-values. In FIG. 23B, boreholes 1-4 are actual boreholes. Boreholes 5-8 are virtual boreholes and are later validated using the real boreholes.

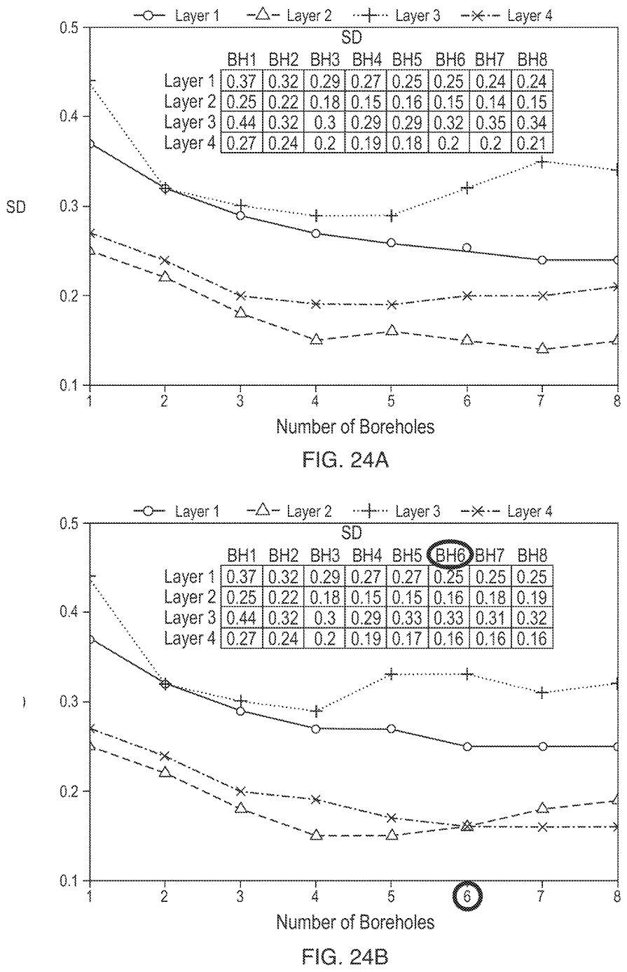

Uncertainty minimization is specified for the shale layer because, for example, most of the piles used in the bridge construction at the case study site are end-bearing piles. The measure of uncertainty SD on the logarithmic scale is approximately equal to the coefficient of variation (COV) on the arithmetic scale. Boreholes 1 to 4, which are in the proximity of the four foundation locations in FIGS. 23A and 23B, provides the actual or preliminary borehole information from the case study. The relative locations for the subsequent boreholes 5 to 8 differ for the two sampling plans (IADOT and conditional simulations). The conditional simulation proposed sampling plan, like the IADOT sampling plan, has geomaterial profile information maximized with boreholes spread across the site. Uncertainties are quantified in FIGS. 24A and 24B for the four geomaterial layers of the different borehole (BH) locations and two sampling plans on the multiple simulated random fields. Here, the idea is to quantify the uncertainties due to the actual boreholes numbered 1 to 4 and determine how the relative locations of subsequent boreholes numbered 5 to 8 will reduce these uncertainties.

The estimated number is selected as the number of boreholes with the minimum SD in the shale as the pile end-bearing layer in which further reduction in SD is no longer worth the additional effort. For the conditional sampling plan, the estimated number of boreholes is 6 as shown in FIG. 24B. The conditional simulation proposed plan has the lowest SD of 0.155 at 6 boreholes compared to the lowest SD of 0.187 obtained from the IADOT sampling plan at 4 boreholes. It is reasonable to compare four boreholes to six boreholes because the current study compares the best performance of these site investigation plans which are at their lowest uncertainties. In most bridge designs, the conditional simulation proposed sampling plan can be ideal for subsurface characterization because it is site-specific. Also, the preliminary borehole information from the foundation locations will be sufficient for spatial analysis of geological and ground uncertainties to recommend subsequent locations of boreholes for the detailed site investigation.

### 2.4. ESIP Validation

The ESIP boreholes can be validated to determine, for example, whether it is an adequate representation of the study site.

The previous validation performed above is done to determine the prediction accuracy of the model and to demonstrate the need to consider geological uncertainty. Validation in this Section 2.4 is done to determine the prediction accuracy of the conditional simulation, to show the need for the recommended boreholes from the ESIP, or combinations thereof.

Boreholes 1 to 6 from the conditional simulation sampling plan in FIG. 23B are denoted as the ESIP boreholes (ESIP BHs). These ESIP BHs are a combination of four actual preliminary boreholes (which are also boreholes 1 to 4 in the IADOT sampling plan denoted as Actual BHs), and two recommended boreholes (boreholes 5 and 6) selected to reduce uncertainty.

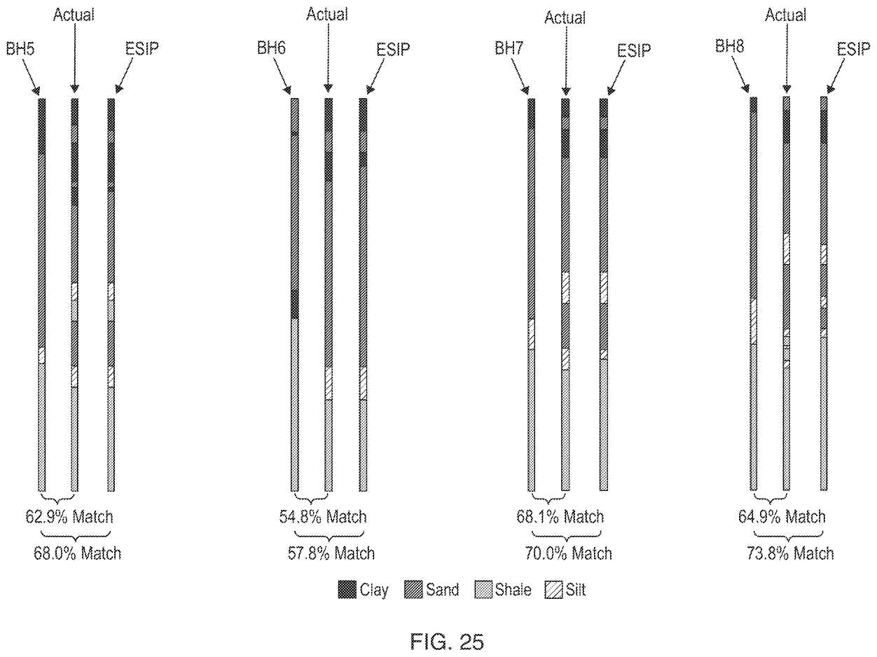

The six boreholes (ESIP BHs) are used as model training data to simulate the geological properties and ground property (predicted log SPT N-values) for the whole subsurface. The four boreholes (boreholes 5 to 8) earlier expunged from the IADOT sampling plan as shown in FIG. 15 and FIG. 23A are used as model testing data to validate the predicted geological properties (predicted geomaterial types) and log SPT N-values earlier obtained. Once the whole subsurface is simulated using data from the four actual and six ESIP boreholes, the predicted geological properties in all four layers of the simulated subsurface at the exact locations of boreholes 5 to 8 are compared to the geological properties sampled in all four layers of boreholes 5 to 8 to determine their percentage match (prediction accuracy) as shown in FIG. 25. The percentage match results are summarized in Table 2-3.

TABLE 2-3
Geological property prediction accuracy

| Site | Percentage match for boreholes 5 to 8 | | | | |
|---|---|---|---|---|---|
| investigation | in the IADOT sampling plan | | | | |
| plan | BH5 | BH6 | BH7 | BH8 | Mean |
| 4 Actual Boreholes | 62.9 | 54.8 | 68.1 | 64.9 | 62.7 |
| 6 ESIP Boreholes | 68.0 | 57.8 | 70.0 | 73.8 | 67.4 |

Overall, the percentage match results as summarized in Table 2-3 show that the six ESIP boreholes have an average 67.4% geological property prediction accuracy compared to the average 62.7% geological property prediction accuracy estimated when four actual boreholes are used as model training data.

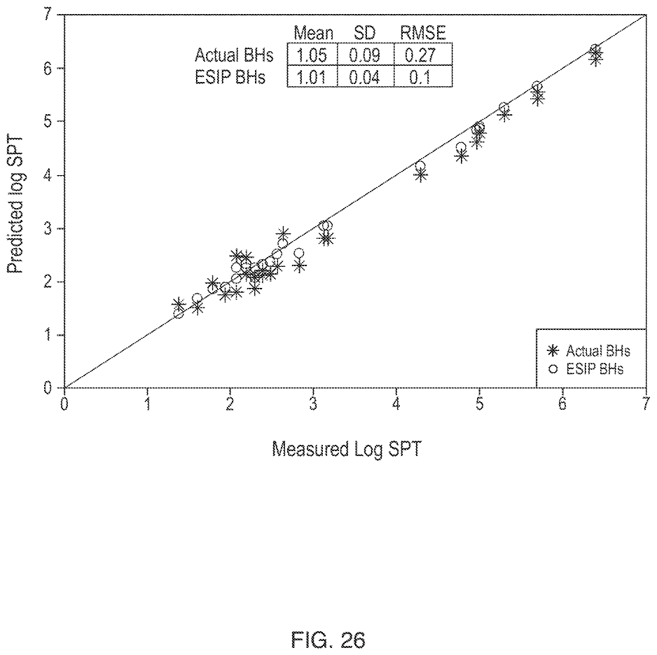

Predicted log SPT N-values at the exact locations of borehole 5 (BH5), borehole 5 (BH6), borehole 7 (BH7), and borehole 8 (BH8) on the simulated subsurface are also compared to the measured log SPT N-values to assess prediction accuracy. The results of validating the ground property (geomaterial property) using the data from the actual preliminary boreholes and the ESIP boreholes are shown in FIG. 26. The results also show that the ESIP boreholes have a better prediction accuracy than the actual preliminary boreholes. The prediction error measured in terms of RMSE (Equation 14) decreased from 27% to 10% with the proposed ESIP. FIG. 26 shows that the validation of the ESIP boreholes is much closer to the equality line compared to that of the actual boreholes with the mean bias of 1.01 closer to unity and a smaller SD of 0.04. This validates the need for the recommended boreholes through the proposed ESIP resulting in a more accurate and consistent prediction of the ground property of the subsurface. In particular, the improved prediction and reduction in uncertainties of a critical geomaterial layer, such as the shale in this case study, can improve the design efficiency and performance of an end-bearing pile foundation.

Example 2 shows that methods for determining the ESIP as described herein, which consider both geological uncertainty and ground uncertainty, can be utilized for bridge design and the results show a significant improvement over conventional methods. Here, analysis of the sparse borehole data from a preliminary site investigation is conducted in 3D to accurately represent the project subsurface. The methodology can involve predicting the geological property and the ground property at unsampled spatial locations of the random field using multinomial categorical prediction and universal kriging, respectively. Geological and ground uncertainties were obtained for these predictions through multiple simulations. Embodiments of the method were compared to that of a recent study that considered only property (ground) uncertainty and was also validated by assessing prediction accuracy and consistency. Various non-limiting conclusions include the following:
(1) Cross-validation of models showed that the average 34% prediction error of the model considering ground uncertainty alone is higher than the average 18% estimated for the model considering both geological property and ground property uncertainties. Hence, the consideration of both geological uncertainty and ground uncertainty, as described herein, significantly improves the model prediction accuracy.
(2) In addition, compared to the IADOT plan with four boreholes and the lowest SD of 0.187, the ESIP determined from the conditional simulation for the IGM layer (layer 4) resulted in the lowest SD of 0.155 at six boreholes. The lower uncertainty resulting from the ESIP improved the design efficiency of bridge foundations.
(3) Further, the validation for six ESIP boreholes included four actual boreholes (same as boreholes 1 to 4 of the IADOT plan) and two recommended boreholes, showing a decrease in the prediction error from 27% to 10%.
(4) The results also demonstrate that considering both geological and ground uncertainties in ESIP provides a better prediction and reduces the uncertainty of a geomaterial response of interest for bridge pile foundations relative to conventional methods.

### Example 3: Estimation of 3D Transition Rates and Probabilities Using Spatial Markov Chains

Spatial Markov Chains (spMC) and information entropy were used in this Example to simulate subsurface geomaterials and to quantify geological uncertainty in two dimensions (2D) based upon spare borehole data. The proposed methods are illustrated using a bridge site in Wyoming.

This Example presents methodology and implementation of a Spatial Markov Chains (spMC) approach with sparse borehole data. The data for this case study came from an actual geotechnical case study at the Lodgepole Creek Bridge replacement project in Wyoming, USA. Selected processes to the systematic in the application of the spMC approach included assigning the borehole data to gridded elements, estimating the transition rate matrices, generating predictions across the study area using the estimated transition matrices, simulations of the predictive, and quantifying the uncertainty of the predictive surfaces. Uncertainty quantification is described using both the confidence level and information entropy across the study area. Such quantifications can be utilized to further consider potential reduction of geological uncertainty through supplementary targeted borehole locations. The spMC methodology utilized in this study was enacted in an R program using a spMC package. This package implements a Markov Random Field (MRF) with various models to predict and simulate the categorical geomaterials.

### 3.1. Project Overview

For Example 3, the project was to replace an existing five-span bridge founded on a reinforced concrete pile over Lodgepole Creek, Approximate M.P. 0.8, Structure CRN. The area of construction is situated in Wyoming (United States). A foundation investigation report by the Wyoming Department of Transportation (WYDOT) consisted of four initial boreholes and two supplementary boreholes making a total of six boreholes. A two-dimensional analysis of geological uncertainty had all boreholes projected to the x-axis centerline while the y-axis was expunged. Five boreholes, instead of the total six boreholes, were used as the conditioned data in this two-dimensional analysis. This was because two boreholes (BH4 and BH6) overlapped each other longitudinally at station 16+78 after the boreholes were projected to the x-axis centerline of the bridge. The spatial study area was +200 ft in the longitudinal (horizontal) distance and −100 ft in depth (vertical distance). The negative sign describing depth was used because the boreholes were drilled below the ground surface. Four geomaterial strata were identified on the project site through the drilled boreholes. The overburden soils included a mixture of sand with silt and gravel, sand, and silt, all underlain by an intermediate geomaterial (IGM) layer of sandy siltstone. There were 20301 discretized elements in the two-dimensional analysis, the size of each square element was +1 ft by −1 ft. The transition rate matrices were estimated using a maximum entropy method.

### 3.2. Estimation of Transition Rate Matrices

Consider two locations s and s+h where s and h are vectors characterizing two-dimensional space. The transition probability (tᵢⱼ(h)) from state (geomaterial) i to state (geomaterial) j is given by Equation 16:

tᵢⱼ(h)=Pr(Z(s+h)=j|Z(s)=i) (Equation 16)

wherein: Pr is probability; Z(s+h) is a categorical random variable for a geological property at another spatial location at a lag distance h; Z(s) is a categorical random variable for a geological property at a spatial location, s; i is the row index; and j is the column index.

The collection of transition probabilities tᵢⱼ(h) across all i,j∈K gives transition probability matrix, T(h), which can also be expressed as

T(h)=exp(∥h∥Rₕ) (Equation 17)

wherein: Rₕ is a transition rate matrix which depends on the direction given by the lag h; and ∥h∥ is the Euclidean distance between s and s+h.

The transition rate of a geomaterial category to itself is a negative value such that the rows of the matrix sum to zero. Estimated transition rate matrices for the vertical and horizontal directions are shown in Table 3-1.

TABLE 3-1
Transition rate matrices obtained
using the maximum entropy method

| | | | | |
|---|---|---|---|---|
| Geological | | Sand with silt | Sandy | |
| category | Sand | and gravel | siltstone | Silt |

Vertical transition rate matrix

| | | | | |
|---|---|---|---|---|
| Sand | −0.6302 | 0.4229 | 0.1114 | 0.0959 |
| Sand with silt | 0.5455 | −0.6875 | 0.0763 | 0.0657 |
| and gravel | | | | |
| Sandy siltstone | 0.0248 | 0.0132 | −0.0410 | 0.0030 |
| Silt | 0.0234 | 0.0125 | 0.0033 | 0.0392 |

Horizontal transition rate matrix

| | | | | |
|---|---|---|---|---|
| Sand | −0.0151 | 0.0068 | 0.0044 | 0.0038 |
| Sand with silt | 0.0141 | −0.0286 | 0.0078 | 0.0067 |
| and gravel | | | | |
| Sandy siltstone | 0.0039 | 0.0033 | −0.0091 | 0.0019 |
| Silt | 0.0037 | 0.0032 | 0.0021 | −0.0089 |

### 3.3. Predictive Surface Modeling

Three simulation approaches were utilized in obtaining a model predictive subsurface. These included CoKriging (CK), Indicator Kriging (IK), and Multinomial Categorical Simulation (MCS). Single simulations from the CK, IK, and MCS were performed to provide one realization of each model predictive surface. Images of one realization of each model predictive subsurface were collected. These simulations were conditioned on the borehole data so that the predictions agreed with the sampled geological property. The conditional simulations from CK and IK looked similar. However, a closer look at the boundary interface of the different geological properties showed that CK predictions had a rough interface unlike the smooth linear interface from IK. Geological uncertainty was evaluated using 100 Monte Carlo simulations. 100 simulations were deemed sufficient because further increase in simulations produced less than +1% change in the uncertainty value. The average of the conditional probabilities was calculated for each geomaterial category across the 100 simulations. The average represented the probability of the geomaterial occurring at a specific discretized element.

### 3.4. Confidence Level and Information Entropy

The geomaterial categories were assigned based upon the geomaterial which had the highest averaged probability across the 100 simulations. A confidence level of 0.9 was utilized to assign the level of prediction of a geomaterial category in each element. This means that an element with a geomaterial category having a probability greater than or equal to the 0.9 confidence level was labeled as ‘certain’ while an element with a geomaterial category having a probability less than the 0.9 confidence level was marked as ‘uncertain’. The confidence ratio is the ratio of the elements in the certain regions divided by the total elements in the discretized region. A confidence image can be used to evaluate the interface location between soil and IGM in the predictive subsurface. Confidence images were collected on the CK model predictive subsurface, IK model predictive subsurface, and MCS model predictive subsurface. More uncertain portions under a confidence level of 0.9 were assigned the lower the confidence ratio of the predictive subsurface. The subsurface confidence ratios for CK, IK, and MCS were determined to be 70.9%, 82.9%, and 91.9%, respectively. Interface locations, which are the continuous uncertain portions between soil and IGM were also visible in the images. Recreating a subsurface with multiple geomaterial layers and boundaries appeared more certain with MCS because of its high confidence ratio.

The information entropy, H, is a measure of the missing information, and is utilized to assess the geological uncertainty of an assigned geomaterial. The information entropy is given by Equation 18:

$$H = - {\sum }_{i = 1}^{K} {p}_{i} {log}_{e} {p}_{i} \qquad ( Equation 18 )$$

wherein: H is information entropy; K is the number of different geological properties; pᵢ is the averaged probability for geomaterial i; and e is logarithm base (it is the same as the number of different geological properties as seen in Equation 6).

Maps of the information entropy and borehole data on the CK model predictive subsurface, IK model predictive subsurface, and MCS model predictive subsurface, were estimated from the 100 simulations.

The average information entropy per element was determined to be 0.068 for CK, 0.074 for IK, and 0.006 for MCS. The “element” refers to the grids or elements of the random field that are separated/discretized during discretization using, for example, R:expand grid. It was found that the geological uncertainty quantified from the information entropy in the discretized elements of MCS located at the conditioned borehole had no information entropy. However, for CK and IK, there were uncertainties despite conditioning on the borehole data. This may be due to the closeness of the two conditioned boreholes. However, MCS was able to effectively condition the data from both boreholes despite their proximity without increasing the uncertainties in the surrounding discretized elements. In terms of computational efficiency (execution time), MCS showed the most substantial improvements compared to CK and IK.

The information entropy in the MCS predictive subsurface was reduced with the addition of suitable boreholes. A process of improving the additional borehole location involves strategically placing the additional boreholes in areas of high uncertainty. These areas are typically where the spatial data is sparse. Here, the information entropy (quantifying the uncertainty) was added together along the depth of each point along the longitudinal axis. A virtual borehole was thereafter placed at the longitudinal location with the highest information entropy. In the two-dimensional analysis of the WYDOT case study, the total information entropy was highest with 0.92 at 121 ft on the longitudinal axis. Since the highest total information entropy of 0.92 is not even up to 1, it may be cost effective drilling a borehole at such a location to reduce quantified geological uncertainty. The two supplementary boreholes added by WYDOT may also have reduced uncertainty if their locations were improved.

Example 3 demonstrates, at least, uncertainty quantification and its possible reduction for application in deep foundations. A case study was presented for the Lodgepole Creek bridge project site in Wyoming to simulate geological properties and to obtain predictive subsurfaces in two dimensions. A comparative assessment of the three types of simulation approaches in spMC showed that MCS can be the most efficient with a confidence ratio of 91.9% and an information entropy of 0.006. The confidence label images collected provided an explicit expression of the predictive subsurface confidence. It also helped to locate the location of the interface between soil and bedrock. The information entropy images provided further visual descriptions of the determined (e.g., quantified) geological uncertainty. Based on these determined uncertainties, an approach to reduce the uncertainties could be used by adding boreholes at improved locations. Reduced uncertainty can improve the confidence of the predictive subsurface and the performance of the deep foundation.

Embodiments of the present disclosure generally relate to methods for developing a site plan, and more specifically to geostatistical methods for developing a site plan.

### EMBODIMENTS LISTING

The present disclosure provides, among others, the following aspects, each of which can be considered as optionally including any alternate embodiments:

Clause A1. A method of determining borehole selection in a geomaterial, the method comprising:
receiving input data from a site, the input data comprising a known geological property, a known ground property, or combinations thereof,
generating a geostatistical prediction and simulation on a random field based on the input data, the generating the geostatistical prediction and simulation on the random field based on the input data comprising:
   determining a geological uncertainty of an unknown geological property at an unsampled spatial location of the random field; and
   determining a ground uncertainty of an unknown ground property at the unsampled spatial location (s₀) of the random field; and
determining an estimated number of one or more boreholes, an estimated location of one or more boreholes, or combinations thereof, based on the geological uncertainty and the ground uncertainty.

Clause A2. The method of Clause A1, wherein: the known geological property comprises a type of the geomaterial, the type of the geomaterial comprising clay, sand, till, shale, weathered shale, silt, gravel, or combinations thereof; the known ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, a depth, or combinations thereof; or combinations thereof.

Clause A3. The method of Clause A1 or Clause A2, wherein the determining the geological uncertainty of the unknown geological property at the unsampled spatial location (s₀) of the random field comprises:
(a) determining an approximation of a conditional probability of the random field using a multinomial categorical prediction according to Equation 5:

$${q}_{j} ( {s}_{0} ) \approx \frac{{p}_{i} {\prod }_{l = 1}^{n} {t}_{{ik}_{l}} ( {s}_{o} - {s}_{l} )}{{\sum }_{i = 1}^{{n}_{S}} {p}_{i} {\prod }_{l = 1}^{n} {t}_{{ik}_{l}} ( {s}_{o} - {s}_{l} )} \qquad ( Equation 5 )$$

wherein: qⱼ(s₀) is the conditional probability of the random field at the unsampled spatial location (s₀); pᵢ is a proportion of an i^{th} category of the unknown geological property in the random field; n is a number of spatial locations in the random field; l is a sampled spatial location index of the random field; nₛ is a number of different geological properties in the random field; i is a geological property index of n and nₛ; and tᵢₖ_{ₗ}(s₀−sₗ) represents a transition probability from geological property zᵢ to another zₖ for observation with index l;
(b) performing a plurality of Monte Carlo simulations on the conditional probability of the random field to propagate the conditional probability;
(c) converting the conditional probability propagated in (b) at the unsampled spatial location to an information entropy of the unknown geological property according to Equation 6:

$${H}_{m} ( {s}_{0} ) = - {\sum }_{j = 1}^{{n}_{s}} {q}_{j , m} ( {s}_{0} ) {log}_{{n}_{s}} {q}_{j , m} ( {s}_{0} ) \qquad ( Equation 6 )$$

wherein: Hₘ(s₀) is information entropy of the unknown geological property at the unsampled spatial location in one Monte Carlo simulation indexed by m of the plurality of Monte Carlo simulations; nₛ is a number of different geological properties in the random field; j in g_{j,m} is an index for the different geological properties; m in q_{j,m} is an index for the Monte Carlo simulation; g_{j,m}(s₀) is qⱼ(s₀) of Equation 5 for one Monte Carlo simulation indexed by m of the plurality of Monte Carlo simulations; and
(d) determining the geological uncertainty by determining a location average information entropy at the unsampled spatial location, H̅(s₀), according to Equation 7:

$$\overline{H} ( {s}_{0} ) = \frac{\sum {H}_{m} ( {s}_{o} )}{{n}_{M}} , \qquad ( Equation 7 )$$

wherein: n_{M} is the total number of Monte Carlo simulations in the plurality of Monte Carlo simulations.

Clause A4. The method of Clause A3, wherein the unknown geological property comprises a type of the geomaterial, the type of the geomaterial comprising clay, sand, till, shale, weathered shale, silt, or combinations thereof.

Clause A5. The method of Clause A3 or Clause A4, wherein the determining the ground uncertainty of the unknown ground property at the unsampled spatial location (s₀) of the random field comprises:
(a) performing universal kriging to obtain a predicted unknown ground property at the unsampled spatial location, ŷ(s₀), according to Equation 10:

$$\hat{y} ( {s}_{0} ) = {\underline{x} ( {s}_{0} )}^{′} \underline{\hat{β}} + \underline{{\hat{v}}^{′}} {\hat{\sum }}^{- 1} ( y ( s ) - X \underline{\hat{β}} ) \qquad ( Equation 10 )$$

wherein: s is a sampled spatial location; s₀ is an unsampled spatial location with an unknown ground property to be predicted; x(s₀)′ is a value of a design matrix for the unknown ground property at s₀; \hat{β} in each instance is a regression coefficient vector of the unknown ground property predicted using generalized least squares; \hat{v}′ is a vector of covariances of the known ground property with entries [symbol] (Y(s₀), Y(sᵢ)) for i=1, . . . , n; \hat{Σ}=\hat{σ}²H(\hat{ρ}) is a restricted maximum likelihood estimate of a covariance matrix Σ; y(s) is a value of the known ground property at s; and X\hat{β} is X multiplied by \hat{β}, where X is a design matrix that contains covariate values for the known ground property at all sampled locations;
(b) conditionally simulating the ŷ(s₀) to produce a predicted ground property ŷᵢ in the plurality of the Monte Carlo simulations n_{M}; and
(c) obtaining a standard deviation of the predicted ground property at the unsampled spatial location according to Equation 11:

$$SD = \frac{1}{{n}_{M} - 1} {\sum }_{i = 1}^{{n}_{M}} {( {\hat{y}}_{i} - \hat{y} )}^{2} \qquad ( Equation 11 )$$

wherein: SD is the standard deviation of the predicted ground property; n_{M} is the number of simulations performed in (b); i indexes each simulation; fj is the predicted ground property for simulations i; and \hat{y̅} is the sample mean of the predicted ground property for each conditional simulation.

Clause A6. The method of Clause A5, wherein the unknown ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, a depth, or combinations thereof.

Clause A7. The method of any one of Clauses A1-A6, further comprising drilling one or more boreholes based on the estimated number of the one or more boreholes determined, the estimated location of the one or more boreholes determined, or combinations thereof.

Clause A8. The method of any one of Clauses A1-A7, further comprising: drilling a borehole based on the estimated number of the one or more boreholes, the estimated location of the one or more boreholes, or combinations thereof.

Clause B1. A method of drilling one or more boreholes at a site, the method comprising:
producing a site investigation plan comprising:
   (a) discretizing a random field into several three-dimensional grids;
   (b) assigning a known geological property to a grid location of the three-dimensional grids, the known geological property based on actual borehole data of actual boreholes;
   (c) estimating a three-dimensional transition rate of the known geological property using a spatial Markov chain;
   (d) predicting an unknown geological property at an unsampled location of the discretized random field by performing a multinomial categorical prediction;
   (e) performing Monte Carlo simulations on the unknown geological property to generate a plurality of realizations;
   (f) characterizing stratigraphic boundaries of each realization of the plurality of realizations to produce stratified realizations;
   (g) assigning a log-transformed known ground property to the stratigraphic boundaries to form a spatial model, the known ground property based on actual borehole data;
   (h) fitting the spatial model with a spatial correlation structure of the log-transformed known ground property;
   (i) predicting an unknown ground property containing the unknown geological property at unsampled locations of the stratified realizations based on the spatial model fit in (h);
   (j) performing conditional simulations on the unknown ground property containing the unknown geological property in the random field to determine ground uncertainty and geological uncertainty resulting from the unknown ground property and unknown geological property, respectively;
   (k) applying the actual boreholes to the conditional simulations of (j);
   (l) adding a plurality of virtual boreholes to locations in the conditional simulations of (j) to provide a plurality of standard deviation values associated with each virtual borehole of the plurality of virtual boreholes;
   (m) selecting a recommended borehole location based on the virtual borehole having the lowest standard deviation value determined in (l); and
   (n) determining an estimated number of boreholes as a number where an additional virtual borehole has a minimal effect on the standard deviation value determined in (m); and
drilling one or more boreholes in accordance with the site investigation plan.

Clause B2. The method of Clause B1, further comprising: repeating (d)-(j) until a change in the ground uncertainty value is less than ±1%.

Clause B3. The method of Clause B1 or Clause B2, wherein: the known geological property comprises a type of the geomaterial, the type of the geomaterial comprising clay, sand, till, shale, weathered shale, silt, gravel, or combinations thereof, the known ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof; or combinations thereof.

Clause B4. The method of Clause B3, wherein: the characteristic of the geomaterial comprises uniaxial compressive strength, compressive strength, thickness, depth, or combinations thereof.

Clause C1. A method for generating a site investigation plan for a pile design, the method comprising:
receiving input data, the input data comprising a known geological property, a known ground property, or combinations thereof,
performing a geostatistical prediction simulation on a random field to predict an unknown ground property at an unsampled pile location based on the input data, the unsampled pile location having a known pile location, the known pile location having an unknown geological property, the unknown ground property, or combinations thereof, and
using the predicted unknown ground property at the unsampled location that is simulated on the random field at the known pile location to determine whether the known pile location has a sufficient end-bearing resistance.

Clause C2. The method of Clause C1, wherein each of the known geological property and the unknown geological property independently comprises a type of geomaterial, the type of geomaterial comprising clay, sand, till, shale, weathered shale, silt, gravel, or combinations thereof.

Clause C3. The method of Clause C1 or Clause C2, wherein each of the known ground property and the unknown ground property independently comprises a characteristic of a geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof.

Clause C4. The method of any one of Clauses C1-C3, wherein the input data comprises data from a current site investigation plan.

Clause C5. The method of any one of Clauses C1-C4, wherein the method further comprises designing the pile by predicting a unit end-bearing resistance of an H-pile.

Clause C6. The method of Clause C5, wherein the predicting the unit end-bearing of the H-pile is performed according to Equation 12:

$${\hat{q}}_{p} ( ksf ) = 45.72 {q}_{u}^{0.35} \qquad ( Equation 12 )$$

wherein: \hat{q}ₚ is the unit end-bearing resistance of the H-pile (in units of ksf); and qᵤ is a uniaxial compressive strength of shale (in units of ksf).

Clause C7. The method of any one of Clauses C1-C6, wherein the performing the geostatistical prediction simulation on the random field to predict the unknown ground property at the unsampled pile location based on the input data comprises: performing simulations on the random field to propagate geological and ground uncertainties.

Clause C8. The method of Clause C7, wherein, after performing simulations on the random field to propagate geological and ground uncertainties, the method further comprises: placing virtual boreholes at locations on the random field to minimize the uncertainties propagated.

Clause D1. A method of determining borehole selection, the method comprising: receiving input data from a site or a random field, the input data comprising a geological property, a ground property, or combinations thereof, generating a geostatistical prediction and simulation on the site or random field; and determining an estimated number of one or more boreholes, an estimated location of one or more boreholes, or combinations thereof, based on the geostatistical prediction and simulation.

Clause D2. The method of claim Clause D1, further comprising drilling one or more boreholes based on the estimated number of one or more boreholes determined, the estimated location of one or more boreholes determined, or combinations thereof.

Clause D3. The method of Clause D1 or Clause D2, wherein: the geological property comprises a geomaterial type, the geomaterial type comprising clay, sand, till, shale, or combinations thereof; the ground property comprises a physical characteristic, the physical characteristic comprising a uniaxial compressive strength, a compressive strength, a thickness, a depth, or combinations thereof; or combinations thereof.

Clause E1. A method of drilling one or more boreholes, the method comprising: determining a site investigation plan according to an embodiment described herein; and drilling one or more boreholes in accordance with the site investigation plan.

Clause F1. A system of drilling a borehole, the system comprising:
a processor;
a memory coupled to the processor;
computer software instructions stored in the memory and executable by the processor, the computer software instructions comprising instructions for:
   receiving information regarding a geological property, a ground property, or combinations thereof of a site or a random field;
   generating a geostatistical prediction and simulation on the site or the random field; and
   determining an estimated number of one or more boreholes, an estimated location of one or more boreholes, or combinations thereof, based on the geostatistical prediction and simulation.

Clause F2. The system of Clause F1, further comprising: drilling the estimated number of one or more boreholes.

Clause G1. A method for incorporating a site investigation plan into a pile design, the method comprising: receiving input data, the input data comprising a site investigation plan; generating a geostatistical prediction simulation on a random field, the geostatistical prediction simulation comprising a geomaterial property; and using the geomaterial property simulated on the random field at a pile location.

Clause G2. The method of Clause G1, wherein the pile is designed using: an equation specific to a geomaterial; an equation specific to a pile type; an equation specific to a geomaterial property simulated on the random field at the pile location; or combinations thereof.

Clause H1. A method of generating a site investigation plan, the method comprising: inputting data from current site investigation plan (CSIP) boreholes in proximity of a pile foundation; and determining a geological characterization, a ground characterization, or combinations thereof of a random field by predicting geomaterial types and geomaterial properties at unsampled locations of the random field.

Clause H2. The method of Clause H1, wherein the determining the geological characterization, the ground characterization, or combinations thereof comprises performing simulations on the random field to propagate uncertainties.

Clause H3. The method of Clause H1 or Clause H2, wherein boreholes are placed at locations on the random field to minimize the uncertainties.

Clause I1. A method of generating a site investigation plan (SIP), the method comprising: performing an initial site investigation plan (ISIP) as input data on a site; generating a geostatistical prediction simulation on the site or a random field; and obtaining an estimated number and location of one or more boreholes for the SIP.

Clause I2. The method of Clause I1, wherein performing the initial site investigation plan includes collecting information on geological properties and ground properties.

Clause I3. The method of Clause I1 or Clause I2, wherein site uncertainties are minimized.

In the foregoing, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the foregoing aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, element, or elements and vice versa, such as the terms “comprising,” “consisting essentially of,” “consisting of” also include the product of the combinations of elements listed after the term.

For purposes of this present disclosure, and unless otherwise specified, the term “coupled” is used herein to refer to elements that are either directly connected or connected through one or more intervening elements.

References cited herein are incorporated by reference herein in their entirety to indicate the state of the art as of their publication or filing date and it is intended that this information can be employed herein, if needed, to exclude specific embodiments that are in the prior art.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a borehole” include aspects comprising one, two, or more boreholes, unless specified to the contrary or the context clearly indicates only one borehole is included.

While the foregoing is directed to embodiments of the present disclosure, other and further embodiments of the disclosure may be devised without departing from the basic scope thereof, and the scope thereof is determined by the claims that follow.

What is claimed is:

1. A method of determining borehole selection in a geomaterial, the method comprising:
receiving input data from a site, the input data comprising a known geological property, a known ground property, or combinations thereof,
generating a geostatistical prediction and simulation on a random field based on the input data, the generating the geostatistical prediction and simulation on the random field based on the input data comprising:
determining a geological uncertainty of an unknown geological property at an unsampled spatial location of the random field; and
determining a ground uncertainty of an unknown ground property at the unsampled spatial location (s₀) of the random field;
determining an estimated number of one or more boreholes, an estimated location of one or more boreholes, or combinations thereof, based on the geological uncertainty and the ground uncertainty; and
drilling a borehole based on the estimated number of the one or more boreholes, the estimated location of the one or more boreholes, or combinations thereof.

2. The method of claim 1, wherein:
the known geological property comprises a type of the geomaterial, the type of the geomaterial comprising clay, sand, till, shale, weathered shale, silt, gravel, or combinations thereof;
the known ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, a depth, or combinations thereof; or
combinations thereof.

3. The method of claim 1, wherein the determining the geological uncertainty of the unknown geological property at the unsampled spatial location (s₀) of the random field comprises:
(a) determining an approximation of a conditional probability of the random field using a multinomial categorical prediction according to Equation 5:
$${q}_{j} ( {s}_{0} ) \approx \frac{{p}_{i} {\prod }_{l = 1}^{n} {t}_{{ik}_{l}} ( {s}_{0} - {s}_{l} )}{{\sum }_{i = 1}^{{n}_{S}} {p}_{i} {\prod }_{l = 1}^{n} {t}_{{ik}_{l}} ( {s}_{0} - {s}_{l} )} \qquad ( Equation 5 )$$
wherein: qⱼ(s₀) is the conditional probability of the random field at the unsampled spatial location (s₀); p₁ is a proportion of an i^{th} category of the unknown geological property in the random field; n is a number of spatial locations in the random field; l is a sampled spatial location index of the random field; nₛ is a number of different geological properties in the random field; i is a geological property index of n and nₛ; and tᵢₖ_{ₗ}(s₀−sₗ) represents a transition probability from geological property Zᵢ to another zₖ for observation with index l;
(b) performing a plurality of Monte Carlo simulations on the conditional probability of the random field to propagate the conditional probability;
(c) converting the conditional probability propagated in (b) at the unsampled spatial location to an information entropy of the unknown geological property according to Equation 6:
$${H}_{m} ( {s}_{0} ) = - {\sum }_{j = 1}^{{n}_{s}} {q}_{j , m} ( {s}_{0} ) {log}_{{n}_{s}} {q}_{j , m} ( {s}_{0} ) \qquad ( Equation 6 )$$
wherein: Hₘ(s₀) is information entropy of the unknown geological property at the unsampled spatial location in one Monte Carlo simulation indexed by m of the plurality of Monte Carlo simulations; nₛ is a number of different geological properties in the random field; j in g_{j,m} is an index for the different geological properties; m in g_{j,m} is an index for the Monte Carlo simulation; g_{j,m}(s₀) is gⱼ(s₀) of Equation 5 for one Monte Carlo simulation indexed by m of the plurality of Monte Carlo simulations; and
(d) determining the geological uncertainty by determining a location average information entropy at the unsampled spatial location, H̅(s₀), according to Equation 7:
$$\overline{H} ( {s}_{0} ) = \frac{\sum {H}_{m} ( {s}_{o} )}{{n}_{M}} \qquad ( Equation 7 )$$
wherein: n_{M} is the total number of Monte Carlo simulations in the plurality of Monte Carlo simulations.

4. The method of claim 3, wherein the unknown geological property comprises a type of the geomaterial, the type of the geomaterial comprising clay, sand, till, shale, weathered shale, silt, or combinations thereof.

5. The method of claim 3, wherein the determining the ground uncertainty of the unknown ground property at the unsampled spatial location (s₀) of the random field comprises:
(a) performing universal kriging to obtain a predicted unknown ground property at the unsampled spatial location, ŷ(s₀), according to Equation 10:
$$\hat{y} ( {s}_{0} ) = {\underline{x} ( {s}_{0} )}^{′} \underline{\hat{β}} + \underline{{\hat{v}}^{′}} {\hat{\sum }}^{- 1} ( y ( s ) - X \underline{\hat{β}} ) \qquad ( Equation 10 )$$
wherein: s is a sampled spatial location; s₀ is an unsampled spatial location with an unknown ground property to be predicted; x(s₀)′ is a value of a design matrix for the unknown ground property at s₀; \hat{β} in each instance is a regression coefficient vector of the unknown ground property predicted using generalized least squares; \hat{v}′ is a vector of covariances of the known ground property with entries [symbol] (Y(s₀), Y(sᵢ)) for i=1, . . . , n; \hat{Σ}=\hat{σ}²H(\hat{ρ}) is a restricted maximum likelihood estimate of a covariance matrix Σ; y(s) is a value of the known ground property at s; and X\hat{β} is X multiplied by \hat{β}, where X is a design matrix that contains covariate values for the known ground property at all sampled locations;
(b) conditionally simulating the ŷ(s₀) to produce a predicted ground property ŷᵢ in the plurality of the Monte Carlo simulations n_{M}; and
(c) obtaining a standard deviation of the predicted ground property at the unsampled spatial location according to Equation 11:
$$SD = \frac{1}{{n}_{M} - 1} {\sum }_{i = 1}^{{n}_{M}} {( {\hat{y}}_{i} - \overline{\hat{y}} )}^{2} \qquad ( Equation 11 )$$
wherein: SD is the standard deviation of the predicted ground property; n_{M} dis the number of simulations performed in (b); i indexes each simulation; ŷᵢ is the predicted ground property for simulations i; and \hat{y̅} is the sample mean of the predicted ground property for each conditional simulation.

6. The method of claim 5, wherein the unknown ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, a depth, or combinations thereof.

7. A method of drilling one or more boreholes at a site, the method comprising:
producing a site investigation plan comprising:
(a) discretizing a random field into several three-dimensional grids;
(b) assigning a known geological property to a grid location of the three-dimensional grids, the known geological property based on actual borehole data of actual boreholes;
(c) estimating a three-dimensional transition rate of the known geological property using a spatial Markov chain;
(d) predicting an unknown geological property at an unsampled location of the discretized random field by performing a multinomial categorical prediction;
(e) performing Monte Carlo simulations on the unknown geological property to generate a plurality of realizations;
(f) characterizing stratigraphic boundaries of each realization of the plurality of realizations to produce stratified realizations;
(g) assigning a log-transformed known ground property to the stratigraphic boundaries to form a spatial model, the known ground property based on actual borehole data;
(h) fitting the spatial model with a spatial correlation structure of the log-transformed known ground property;
(i) predicting an unknown ground property containing the unknown geological property at unsampled locations of the stratified realizations based on the spatial model fit in (h);
(j) performing conditional simulations on the unknown ground property containing the unknown geological property in the random field to determine ground uncertainty and geological uncertainty resulting from the unknown ground property and unknown geological property, respectively;
(k) applying the actual boreholes to the conditional simulations of (j);
(l) adding a plurality of virtual boreholes to locations in the conditional simulations of (j) to provide a plurality of standard deviation values associated with each virtual borehole of the plurality of virtual boreholes;
(m) selecting a recommended borehole location based on the virtual borehole having the lowest standard deviation value determined in (l); and
(n) determining an estimated number of boreholes as a number where an additional virtual borehole has a minimal effect on the standard deviation value determined in (m); and
drilling one or more boreholes in accordance with the site investigation plan.

8. The method of claim 7, further comprising:
repeating (d)-(j) until a change in the ground uncertainty value is less than +1%.

9. The method of claim 7, wherein:
the known geological property comprises a type of the geomaterial, the type of the geomaterial comprising clay, sand, till, shale, weathered shale, silt, gravel, or combinations thereof;
the known ground property comprises a characteristic of the geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof; or
combinations thereof.

10. The method of claim 9, wherein:
the characteristic of the geomaterial comprises uniaxial compressive strength, compressive strength, thickness, depth, or combinations thereof.

11. A method for generating a site investigation plan for a pile design, the method comprising:
receiving input data from a site investigation plan, the input data comprising a known geological property, a known ground property, or combinations thereof,
performing a geostatistical prediction simulation on a random field to predict an unknown ground property at an unsampled pile location based on the input data, the unsampled pile location having a known pile location, the known pile location having an unknown geological property, the unknown ground property, or combinations thereof; and
using the predicted unknown ground property at the unsampled location that is simulated on the random field at the known pile location to determine whether the known pile location has a sufficient end-bearing resistance.

12. The method of claim 11, wherein each of the known geological property and the unknown geological property independently comprises a type of geomaterial, the type of geomaterial comprising clay, sand, till, shale, weathered shale, silt, gravel, or combinations thereof, and wherein each of the known ground property and the unknown ground property independently comprises a characteristic of a geomaterial, the characteristic comprising color, texture, structure, porosity, pore size, permeability, particle density, bulk density, adhesion, cohesion, consistency, temperature, stability, resistivity, uniaxial compressive strength, compressive strength, shrink-swell rate, water-holding capacity, susceptibility to erosion, infiltration, thickness, depth, or combinations thereof.

13. The method of claim 11, wherein the method further comprises designing the pile by predicting a unit end-bearing resistance of an H-pile, wherein the predicting the unit end-bearing of the H-pile is performed according to Equation 12:
$${\hat{q}}_{p} ( ksf ) = 45.72 {q}_{u}^{0.35} \qquad ( Equation 12 )$$
wherein: \hat{q}ₚ is the unit end-bearing resistance of the H-pile (in units of ksf); and qᵤ is a uniaxial compressive strength of shale (in units of ksf).

14. The method of claim 11, wherein the performing the geostatistical prediction simulation on the random field to predict the unknown ground property at the unsampled pile location based on the input data comprises:
performing simulations on the random field to propagate geological and ground uncertainties.

15. The method of claim 14, wherein, after performing simulations on the random field to propagate geological and ground uncertainties, the method further comprises:
placing virtual boreholes at locations on the random field to minimize the uncertainties propagated.
